(19) United States
(12) Patent Application Publication
(10) Pub. No.: US 2023/0237545 A1
(43) Pub. Date: Jul. 27, 2023

(54) SYSTEM AND METHOD FOR PREDICTING PROJECT PRICING BASED UPON USING PROJECT TEMPLATES

(71) Applicants: Patrick J. Dougherty, Hawley, PA (US); Robert K. Ace, JR., East Stroudsburg, PA (US)

(72) Inventors: Patrick J. Dougherty, Hawley, PA (US); Robert K. Ace, JR., East Stroudsburg, PA (US)

(21) Appl. No.: 18/059,415

(22) Filed: Nov. 28, 2022

Related U.S. Application Data
(60) Provisional application No. 63/301,981, filed on Jan. 21, 2022.

(51) Int. Cl. G06Q 30/0283; G06Q 10/087; G06Q 10/0631

(52) U.S. Cl. CPC G06Q 30/0283; G06Q 10/087; G06Q 10/06313

(57) ABSTRACT

Systems, methods, and other embodiments for predicting project pricing based upon project templates such as for use in the renovation and construction of buildings. In particular, the present invention interactively creates customer estimates and vendor specifications, and more specifically interactively creates customer estimates and vendor specifications that are less subjective and produce similar, repeatable results when run by different users.

### CROSS-REFERENCE TO RELATED APPLICATION

This application is a continuation-in-part of U.S. Patent Application 63/301,981, filed on Jan. 21, 2022, the disclosure of which is hereby incorporated by reference in its entirety to provide continuity of disclosure to the extent such a disclosure is not inconsistent with the disclosure herein.

### FIELD OF THE INVENTION

The present invention relates to a system and method that is capable of predicting project pricing based upon project templates such as for use in the renovation and construction of buildings. In particular, the present invention interactively creates customer estimates and vendor specifications, and more specifically interactively creates customer estimates and vendor specifications that are less subjective and produce similar, repeatable results when run by different users.

### BACKGROUND

One of the most significant issues with developing a dynamic quoting system for residential construction is that every company does things differently. Products, techniques, costs of goods, and services vary between companies. Codes and site-specific requirements vary per project and geographic location. Additionally, architectural design, overall budget, and customer requests and requirements create another set of variables that further complicate the process. These factors combine to create circumstances that need to be addressed to determine and quote an accurate price.

Because of these variables, estimates are compiled and calculated line by line. Small projects like kitchen and bath remodels can have hundreds of line items, whereas more extensive remodels or new homes can create thousands of line items. This process of creating estimates is time-consuming, complicated, and prone to errors. Furthermore, once an estimate is complete, the estimator needs to create a more specific document for the customer that summarizes what is included. This document is referred to as the specification document. The specification document, building plans, and contract create a comprehensive legal agreement between the builder and the customer.

Because the specification document is typically created separately from the estimate, errors, and omissions, and other differences between the documents commonly occur. These errors and omissions are even more common once a customer requests changes to the project after the price and specifications have been determined. The disconnect between what is included in the estimate and what is represented in the specification document can lead to unwanted and costly customer disputes and cause internal confusion within the production team.

There have been suggestions to use the estimate as the specification document. There are several reasons why this would not be feasible.

The estimate provides the company with internal business information that can be viewed in multiple ways and helps determine labor requirements, cash flow projections, purchase order generation, and scheduling information that companies would not want the public to see.

Providing documentation at the estimate item level of detail would not provide the customer with a clear understanding of what has been included. Therefore, building specification documents are created.

There are many different possibilities since there are so many items, assemblies, and tasks involved with renovations and construction. Each one will have different materials, labor, and costs. Typically, the potential customer sits with an estimator and goes through various versions while the estimator calculates the costs of each version. The estimator must have enough building knowledge to know which items and assemblies are compatible; and what items and assemblies are required to finish the tasks. This process can take up a significant amount of time for a high-level employee. It would not be as costly if the person working with the potential customer were a lower-level employee. However, the current building estimation systems require an employee with significant building knowledge to operate them.

There is currently a need for a quotation system that allows a user without extensive building knowledge to accurately and repeatedly generate estimates and job specifications for the same job with few errors or omissions.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be implemented as multiple elements or that multiple elements may be implemented as one element. In some embodiments, an element shown as an internal component of another element may be implemented as an external component and vice versa. Furthermore, elements may not be drawn to scale.

FIG. 1 illustrates one embodiment of a system for predicting project pricing based upon using project templates.

FIG. 2 illustrates one embodiment of a template category for the system for predicting project pricing based upon using project templates.

FIG. 3 illustrates one embodiment of a template subcategory for the system for predicting project pricing based upon using project templates.

FIG. 4 illustrates one embodiment of profit and contingency information for a quotation template for the system for predicting project pricing based upon using project templates.

FIG. 5 illustrates one embodiment of quotation template sections for the system for predicting project pricing based upon using project templates.

FIG. 6 illustrates one embodiment of a window for adding and organizing sections within a quotation template for the system for predicting project pricing based upon using project templates.

FIG. 7 illustrates one embodiment of a window for adding new questions within a quotation template for the system for predicting project pricing based upon using project templates.

FIG. 8 illustrates one embodiment of a window for adding new answers within a quotation template for the system for predicting project pricing based upon using project templates.

FIG. 9 illustrates one embodiment of selecting the correct quotation template for the system for predicting project pricing based upon using project templates.

FIG. 10 illustrates one embodiment of a grid that shows how the quotation template information is separated and stored for the system for predicting project pricing based upon using project templates.

FIG. 11 illustrates one embodiment of an add button for the questions column for the system for predicting project pricing based upon using project templates.

FIG. 12 illustrates one embodiment of selecting a question to add to the question section of the quotation template for the system for predicting project pricing based upon using project templates.

FIG. 13 illustrates one embodiment of the new question being added to the question column for the system for predicting project pricing based upon using project templates.

FIG. 14 illustrates one embodiment of selecting the add button for the system for predicting project pricing based upon using project templates.

FIG. 15 illustrates one embodiment of selecting a possible answer for the system for predicting project pricing based upon using project templates.

FIG. 16 illustrates one embodiment of selecting the add button on the answer window for the system for predicting project pricing based upon using project templates.

FIG. 17 illustrates one embodiment of how the answer appears on the questions for the system for predicting project pricing based upon using project templates.

FIG. 18 illustrates one embodiment of adding the remaining answers to the question for the system for predicting project pricing based upon using project templates.

FIG. 19 illustrates one embodiment of selecting the add button that will to allow the selection to be added to the database for the system for predicting project pricing based upon using project templates.

FIG. 20 illustrates one embodiment of selecting a database to pair with the answer for the system for predicting project pricing based upon using project templates.

FIG. 21 illustrates one embodiment of selecting an add button to add an item to the database for the system for predicting project pricing based upon using project templates.

FIG. 22 illustrates one embodiment of the response being added to the answer for the system for predicting project pricing based upon using project templates.

FIG. 23 illustrates one embodiment of the remaining responses being added to the answer for the system for predicting project pricing based upon using project templates.

FIG. 24 illustrates one embodiment of selecting the finish tab to add the quotation template to the list of templates for the system for predicting project pricing based upon using project templates.

FIGS. 25A and 25B illustrate one embodiment of a method for training a machine learning model with known project templates.

FIG. 26 illustrates one embodiment of a home screen for a quotation template for the system for predicting project pricing based upon using project templates.

FIG. 27 illustrates one embodiment of quotation template listing for the system for predicting project pricing based upon using project templates.

FIG. 28 illustrates one embodiment of adding a new quotation template for the system for predicting project pricing based upon using project templates.

FIG. 29 illustrates one embodiment of selecting the correct quotation template category for the project for the system for predicting project pricing based upon using project templates.

FIG. 30 illustrates one embodiment of selecting the desired quotation template for the system for predicting project pricing based upon using project templates.

FIG. 31 illustrates one embodiment of the various sections in a quotation template for the system for predicting project pricing based upon using project templates.

FIG. 32 illustrates one embodiment of the various questions in a particular section for the system for predicting project pricing based upon using project templates.

FIG. 33 illustrates one embodiment of the selection of one of the answers being added to the section for the system for predicting project pricing based upon using project templates.

FIG. 34 illustrates one embodiment of selecting the answers for the other relevant sections in the quotation template for the system for predicting project pricing based upon using project templates.

FIG. 35 illustrates another embodiment of selecting the answers for other sections in the quotation template for the system for predicting project pricing based upon using project templates.

FIG. 36 illustrates one embodiment of updating the quantity to the quotation template for the system for predicting project pricing based upon using project templates.

FIG. 37 illustrates one embodiment of saving the quotation template for the system for predicting project pricing based upon using project templates.

FIG. 38 illustrates one embodiment of the saved quotation template being displayed with the other quotation templates for the system for predicting project pricing based upon using project templates.

FIG. 39 illustrates one embodiment of selecting the report tab for the system for predicting project pricing based upon using project templates.

FIG. 40 illustrates one embodiment of a display for generating the quotation summary PDF for the system for predicting project pricing based upon using project templates.

FIG. 41 illustrates one embodiment of the different reports that are available for the system for predicting project pricing based upon using project templates.

FIG. 42 illustrates one embodiment of a quotation summary report for the system for predicting project pricing based upon using project templates.

FIG. 43 illustrates one embodiment of a work order report for the system for predicting project pricing based upon using project templates.

FIG. 44 illustrates one embodiment of an all in one report for the system for predicting project pricing based upon using project templates.

FIG. 45 illustrates one embodiment of a specifications report for the system for predicting project pricing based upon using project templates.

FIG. 46 illustrates one embodiment of a spreadsheet report for the system for predicting project pricing based upon using project templates.

FIG. 47 illustrates an embodiment of a special purpose computing system configured with the example systems and/or methods disclosed.

### DETAILED DESCRIPTION

Systems and methods are described herein that predict project pricing based upon using project templates. In one embodiment, the present technique includes at least one customized known question and answer related to the known item, known assembly, and/or known project wherein a known answer is to be selected by the end user (i.e., customer). Based upon the answer selected by the end user, the system can then predict project pricing based upon using the known answer that was selected by the end user (i.e., customer). Typically, the answer will be related to an item and/or assembly that will be needed to complete the project.

In another embodiment, a machine learning model can be used since the machine learning model can learn from its own performance and modify its own predictions. In particular, the pricing associated with the completed project can be updated to provide current, market-based pricing. The machine learning model can obtain the current, market-based pricing and determine which vendor is providing the best pricing (i.e., lowest pricing) for the completion of the project.

In another embodiment, the machine learning model can receive information related to item pricing, assembly pricing, and/or project pricing. The machine learning model is configured to identity a particular item and/or assembly related to a project and determine if the pricing related to the particular item and/or assembly has changed. If the pricing related to the particular item and/or assembly has changed, the machine learning model is configured to update the pricing related to the particular item and/or assembly.

In one embodiment, item refers to a singular item required to complete a project (such as an installation of a new sink in a kitchen remodeling project). The assembly refers to a plurality of items required to complete a sub-project (such as a sink installation and the countertop installation in a kitchen remodeling project). Finally, a project refers to a plurality of items and/or assemblies required to complete the project (such as the sink and countertop assembly installation and the installation of a new refrigerator in a kitchen remodeling project).

In one embodiment, all of the data related to items and/or assemblies that a particular client (i.e., contractor) will need to complete a project will be stored in a persistent database that can be accessed by the client and/or an end user through the system. In another embodiment, the data will include, among other things, data associated with the identification of the particular item and/or assembly such as an item number and an assembly number. The item database will also include a price associated with the current price of the item and/or the assembly. For example, the item database may include information that such items as refrigerators and sinks are being offered by the client for installation in the end user's project.

In another embodiment, the item database can also store additional information at the item level for generating reports such as vendor, item selection information, accounting information, item cost, job cost code, item specification content, location tag, upgrade information, digital catalog controls, and content. In short, the item database will include information that identifies the particular refrigerators and sinks by a particular item identifier specific to each of the different refrigerators and sinks (such as refrigerator1, refrigerator2, sink1, and sink 2).

In another embodiment, the item/assembly/product database will also include an assembly level database (“assembly level”) having data associated with the identification of the particular assembly such as an assembly number. The assembly level will also include a price associated with the current price of the assembly. For example, the assembly level may include information that such assemblies are being offered by the client such as the installation of a kitchen sink and a countertop in the end user's project. In another embodiment, the assembly level stores groups of items from the item database along with formulas that share a common takeoff quantity to create an assembly so that multiple Items can be calculated at the same time. In short, the assembly level will include information that identifies the particular assembly by a particular assembly identifier (such as sink/countertop assembly1, sink/countertop assembly2, etc.).

In another embodiment, the item/assembly/product database will also include a product level database (“product level”) having data associated with the identification of the particular product such as a product number. The product level will also include a price associated with the current price of the product. For example, the product level may include information that such products are being offered by the client such as the remodeling of a kitchen. In another embodiment, the product level stores estimates that represent a specific design, project type or option that consist of Items and assemblies. In short, the product level will include information that identifies the particular product by a particular product identifier (such as kitchen remodel1, kitchen remodel2, etc.).

In another embodiment, a current price for each of the items, assemblies, and/or products can also be associated with the particular item, assembly, and/or product and will be stored in the item/assembly/product database. A unique aspect of the present invention is that the vendors who will be providing the materials to complete the project will maintain a database of the current prices of the items that vendor will sell to the client that the client may need in order to complete the project for the end user. The machine learning model is configured to query the item/assembly/product database and the vendor's database to determine if a price for a particular item has changed. If the item price has changed, the machine learning model is configured to update the pricing data associated with that particular item. Also, the machine learning model is configured to update the pricing of any assemblies and/or projects that include that particular item.

A practical application of the present invention is the use of the machine learning model to select the vendor who will provide the best (i.e., lowest) price for a particular item and/or provide the best (i.e., most reliable) service in relation to a particular item, assembly and/or product. In particular, as discussed above, the machine learning model is configured to update the pricing of any assemblies and/or projects that include that particular item. In this manner, if a particular item is requested by a client, the machine learning model is configured to query the item database and retrieve information related to the particular item such as vendor, selections, accounting information, vendor delivery of the item, cost, job cost code, specification content, location tag, upgrade information, selection information, digital catalog controls, and content. The machine learning model is then configured to determine the lowest cost for the particular item and return to the client the lowest cost for that item and the vendor associated with the lowest cost. The client can then determine if the client wishes to purchase the particular item from the vendor.

In another unique aspect of the present invention, the machine learning model is also configured to determine a preferred vendor for a particular item, assembly and/or project. In particular, the machine learning model is configured to update the vendor information related to any item that the client is offering. In this manner, if a price for a particular item that the vendor is selling is consistently higher than other vendors of the same item or the vendor is consistently late in delivering the item that is being requested by a client, the machine learning model is configured to query the item database and retrieve information related to the particular item such as vendor and vendor delivery information. The machine learning model is then configured to determine which vendor is selling the particular item at the lowest cost and if that vendor has had delivery issues in the past (i.e., the vendor is a preferred or non-preferred vendor) and return to the client the lowest cost for that item and the vendor delivery information associated with the lowest cost. The client can then determine if the client wishes to purchase the particular item from the vendor.

Another practical application is the determination of the preferred/non-preferred vendor status. The machine learning model is configured to determine if a vendor is a preferred or non-preferred vendor by determining if the particular vendor has had delivery issues in the past by querying the vendor delivery information. For example, if the delivery information for a particular vendor shows that the vendor is timely in its deliveries (deliveries are made by the agreed upon delivery date), then that vendor may be designated by the machine learning model as a “preferred vendor”. If the vendor is not timely in its deliveries (deliveries are regularly made after the agreed upon delivery date), then that vendor may be designated by the machine learning model as a “non-preferred vendor.” It is to be understood that other factors related to the vendor can be analyzed by the machine learning model to determine if a vendor is to be designated as a preferred or non-preferred vendor. Finally, it is to be understood that although a vendor may be designated as a non-preferred vendor, the client and the end user may decide to use that non-preferred vendor to supply the item, assembly and/or product because that non-preferred vendor may be the only vendor who can supply that particular item, assembly, and/or product.

In one embodiment, the present technique generates a predicted project price based upon project templates. In particular, the client can prepare a template, or a series of templates related to a particular item, assembly, or project. For example, if the client is going to offer an item such as a sink, the client can prepare a template that sets forth questions to be answered by the end user related to the item. In particular, the client can configure the templates to query the end user (i.e., ask a question) as to the sink model the end user desires to obtain from the client. In this manner, the end user is presented with a template that includes all of the sink models that the client offers. The template will include a menu such as a drop-down menu that allows the end user to select the desired sink model from among different sink models that the client offers.

A practical application of the present technique is that upon the user selecting the desired sink (i.e., the end user answers the question by selecting a desired item), the machine learning model then queries the item database (i.e., requests a response from the database) to determine which vendor is offering the lowest price on the selected item (and, if necessary, determines if the vendor also a preferred/non-preferred vendor, as discussed above).

Upon determining which vendor is selling the item at the lowest price (and, if necessary, determining if the vendor also a preferred/non-preferred vendor), the machine learning model then transmits the vendor information to the client along with the price associated with the selected item.

In another practical application, the system is configured to transmit the vendor information and item price to the client as part of a client report that is only to be used by the client and the system is also configured to transmit a different report that is to be presented to the end user. In this manner, the system prepares and transmits an internal business report such as a quotation summary report for use by the client and/or the vendor. For example, the internal business report will show the cost and descriptions of all of the items and assemblies needed to complete a project and includes a summary of all of the information from the templates in which the client/end user provided information. Furthermore, the internal business report could include item/assembly costs based upon the quantity required for completion of the project and a profit margin. Accordingly, the present system generates a prediction model that predicts project pricing based upon project templates.

In one embodiment, the system may generate an electronic message with the predicted project pricing and transmits the electronic message via a network communication to a remote computer associated with the client and/or vendor. In one embodiment as described below, the electronic message is generated as (and/or includes) control instructions for a robotic mechanism of an inventory system.

In another practical application, the system is configured to also prepare a different report that includes the item/assembly information along with a quotation total for all of the items/assemblies needed to complete the project for subsequent presentation and consideration by the end user. For example, the system is configured to prepare a report that will be included in a project contract between the client and the end user, wherein the report will be an in-depth customer facing report that provides details on the project in plain language, identifies what is and what is not included in the project, images, description of project construction methods, vendors, item/assembly quantities, project location, and the like. Accordingly, the present system generates a prediction model that predicts project pricing based upon project templates.

In one embodiment, the system may generate an electronic message with the predicted project pricing and transmits the electronic message via a network communication to a remote computer associated with the end user, where the message is used to initiate an action from an end user or client. The electronic message may be generated with a link that is configured to provide network-accessible access to a selected website location over a network communication. The link and selected website location may include reports that may cause the end user and/or client to review the report.

### Machine Learning Model for Predicting Project Pricing

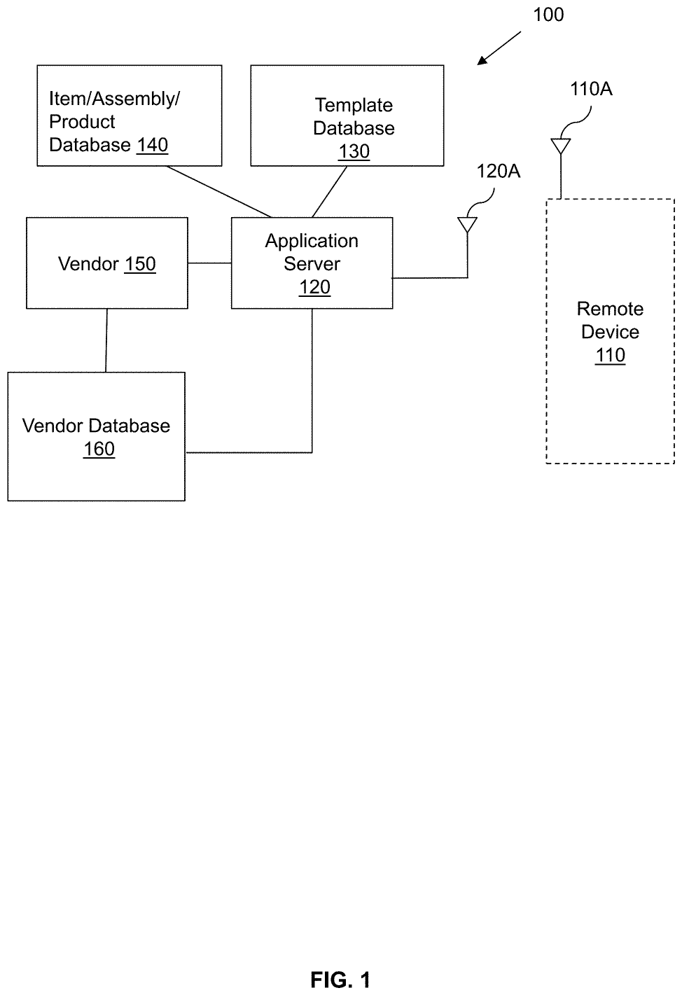

With reference to FIG. 1, one embodiment of a system 100 for predicting project pricing based upon using project templates is illustrated. The system 100, includes, in part, remote device 110 having a transceiver 110A, an application server 120 having a transceiver 120A, a template database 130, an item/assembly/product database 140, a vendor 150, and a vendor database 160.

In one embodiment, remote device 110 can be, but is not limited to, a smartphone, tablet, laptop or other similar computing device that is capable of interacting with the application server 120 through transceiver 110A. Furthermore, remote device 110 should be capable of allowing a client and/or an end user to interact with application server 120 through a mobile application or browser that can be accessed by the remote device 110. As will be discussed in greater detail later, the mobile application or browser on the remote device 110 will allow the user to interact with the application server 120 in order to allow the user to interact with the template database 130 and the item/assembly/product database 140, the vendor 140, and the vendor database 160. For example, the remote device 110 can be used by the client and the end user to interact with the template database 130 and the item/assembly/product database 140, as will be discussed in greater detail later. The remote device 110 can be used by the client to interact with the vendor and the vendor database 160, as will be discussed in greater detail later.

In one embodiment, application server 120 includes transceiver 120A so that application server 120 is capable of interacting with the remote device 110 and provide the client and/or the end user with related data requested by the application server 120 from the template database 130, the item/assembly/product database 140, and the vendor database 160, as will be discussed in greater detail later. Furthermore, as will be discussed in greater detail later, the information related to each item in the item database, the assembly in each assembly database, and the product in each product database will be constantly updated by the vendor (or a third party) so that, for example, the most current price for each item, assembly, and/or product will be available to the client and/or the end user.

### Template Database

In one embodiment, template database 130 is configured to store all the quotation templates prepared by the client that are related to the items and assemblies that the client needs to complete a project (“project”).

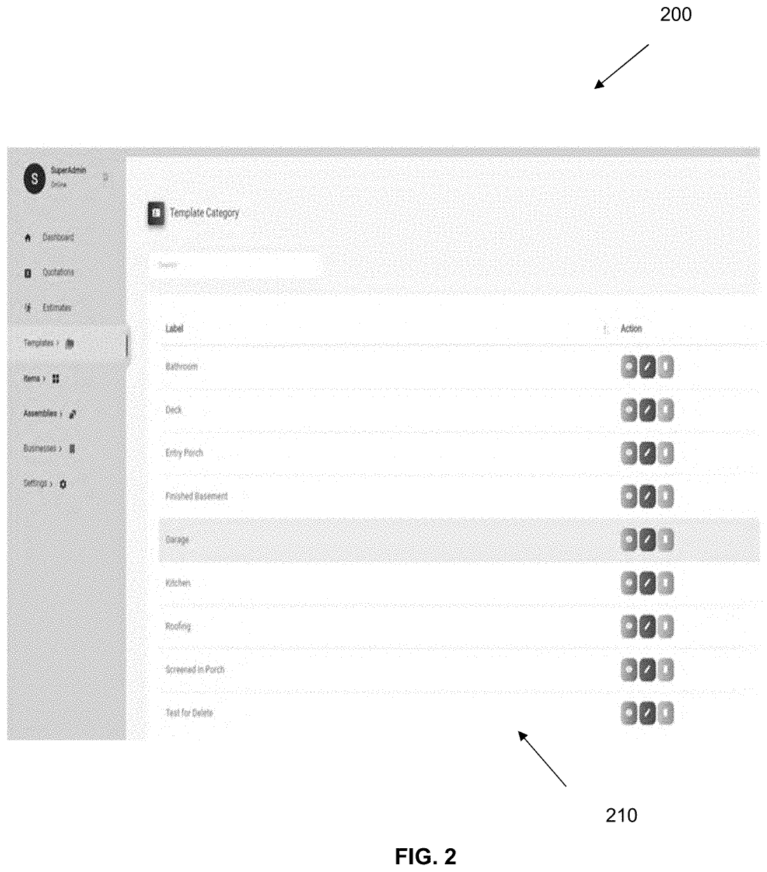

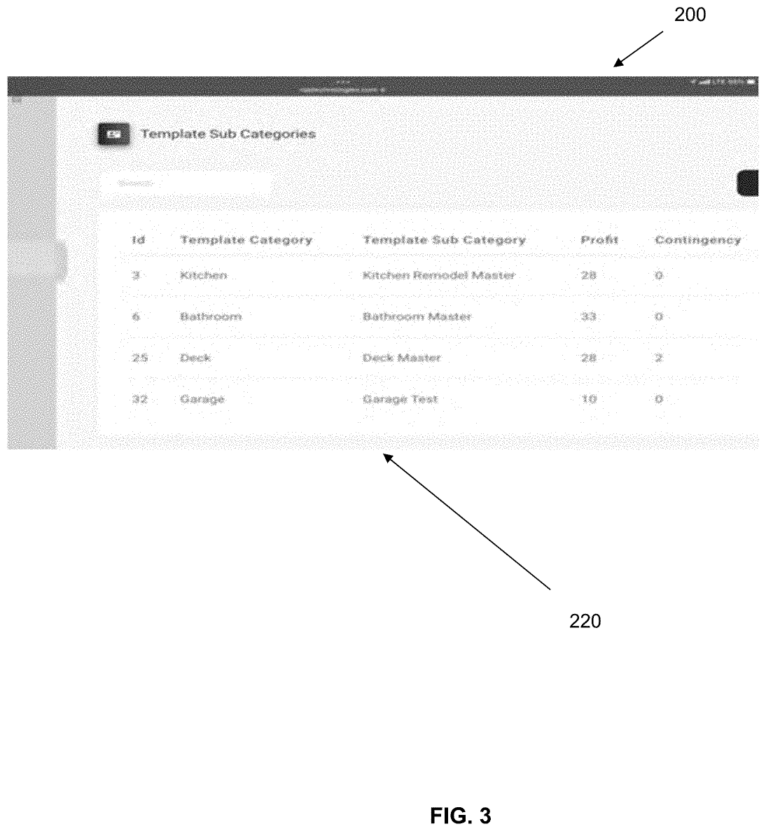

Another practical application is the creation of the quotation templates 200. As shown in FIGS. 2 and 3, (2) different filters, namely, categories 210 and sub-categories 220 are created and stored on the quotation templates 200. In one embodiment, the category 210 may be, but is not limited to, a major project such a kitchen remodel, a basement remodel, a bathroom remodel, or the like. Also, a sub-category 220 may be, but is not limited to, a kitchen remodel master, bathroom remodel master, basement remodel master, or the like.

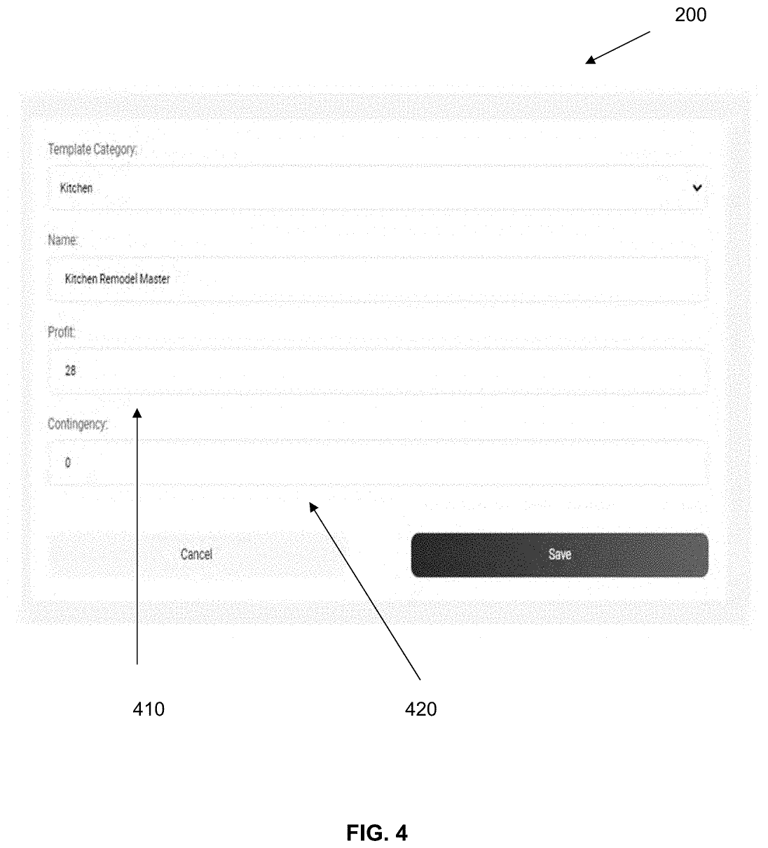

Once the category and sub-category filters have been added to the quotation template 200, as shown in FIG. 4, a profit 410 and other contingency information 420 can be added to each quotation template 200 so that the pricing structure is uniform for anyone using the quotation template.

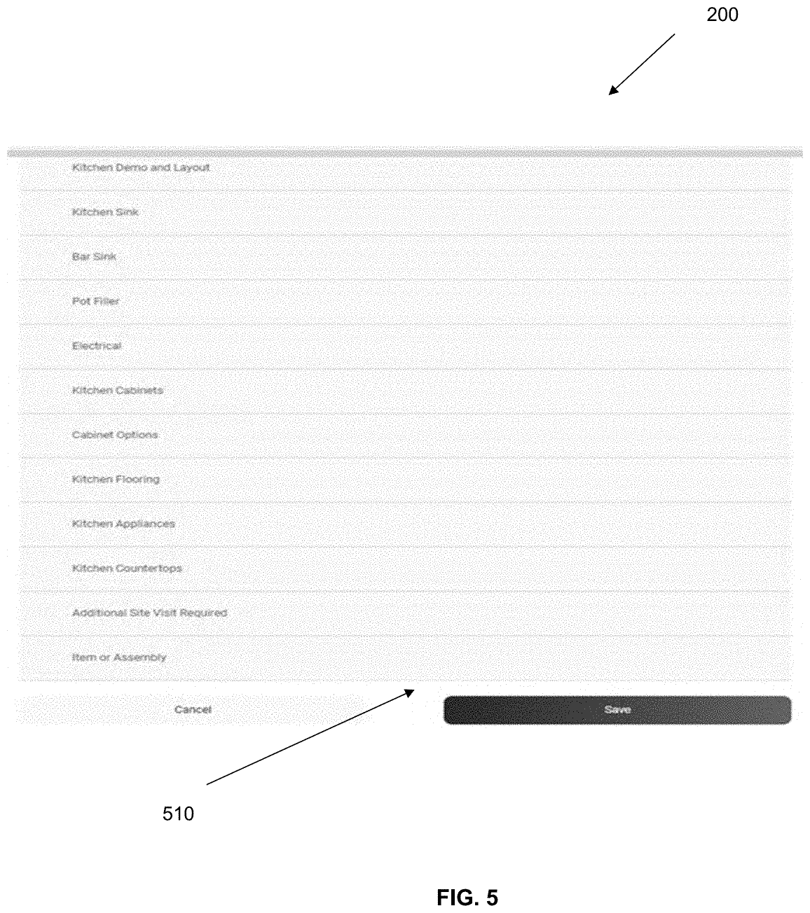

With reference to FIG. 5, after the profit 410 and other contingency information 420 have been added to each quotation template 200, the client then creates the sections 510 that are to appear in each quotation template 200. In one embodiment, this is where the questions and answers will nest for the end user to select.

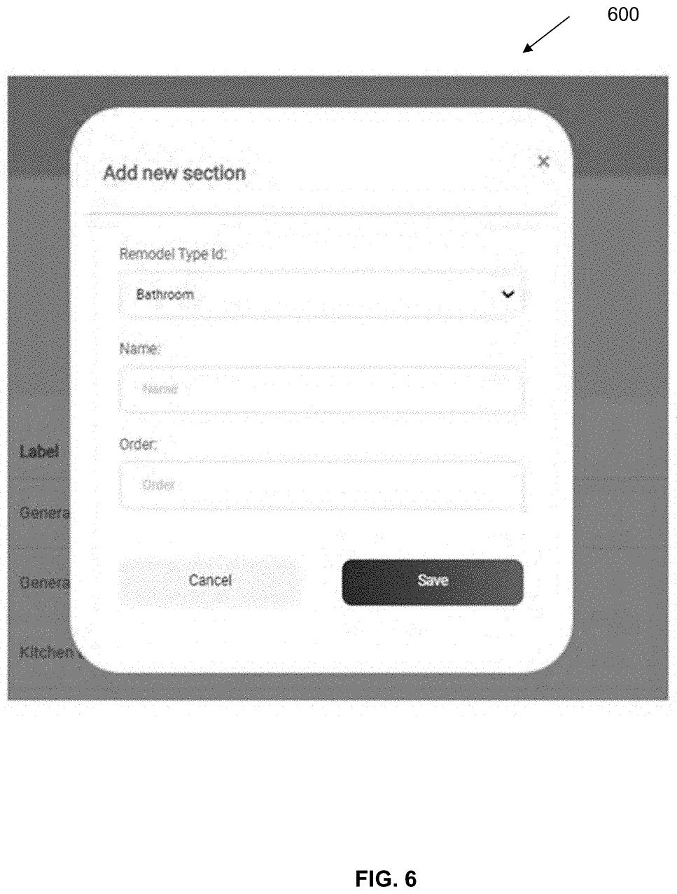

In particular, as shown in FIG. 6, the application server 120 is configured to provide a window 600 for adding and organizing sections within a quotation template 200.

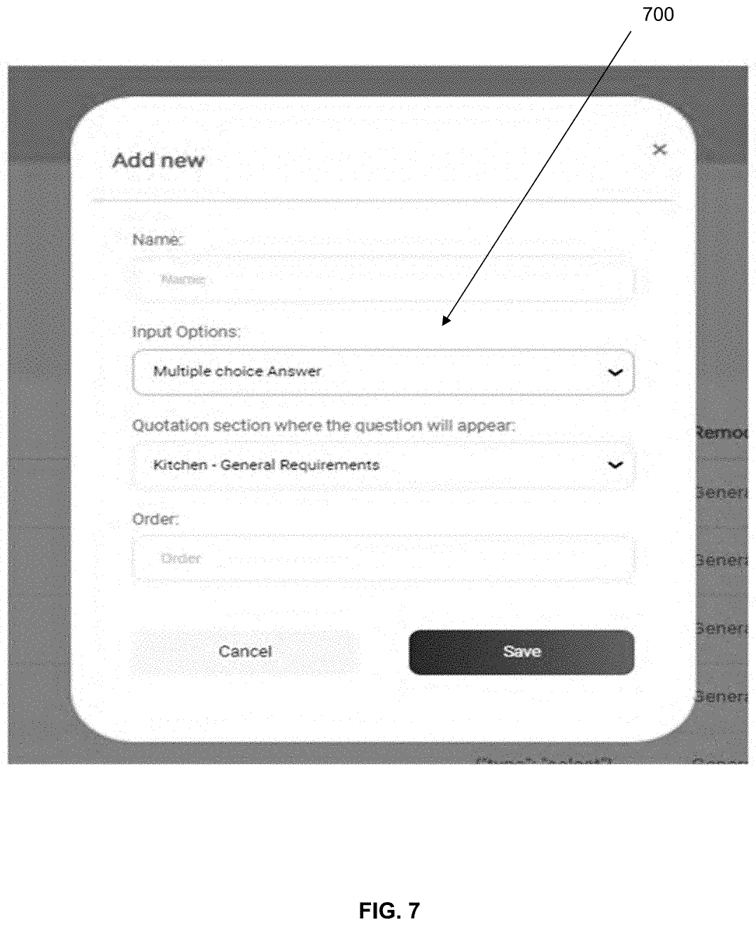

As shown in FIG. 7, in one embodiment, if needed, the client can add more questions 700 to a quotation template to address further needs and/or requests from the client and the end user. In one embodiment, when the questions 700 are created by the client, the application server 120 is configured to assign the questions 700 to a specific quotation template 200 and a specific section 510 within the quotation template 200.

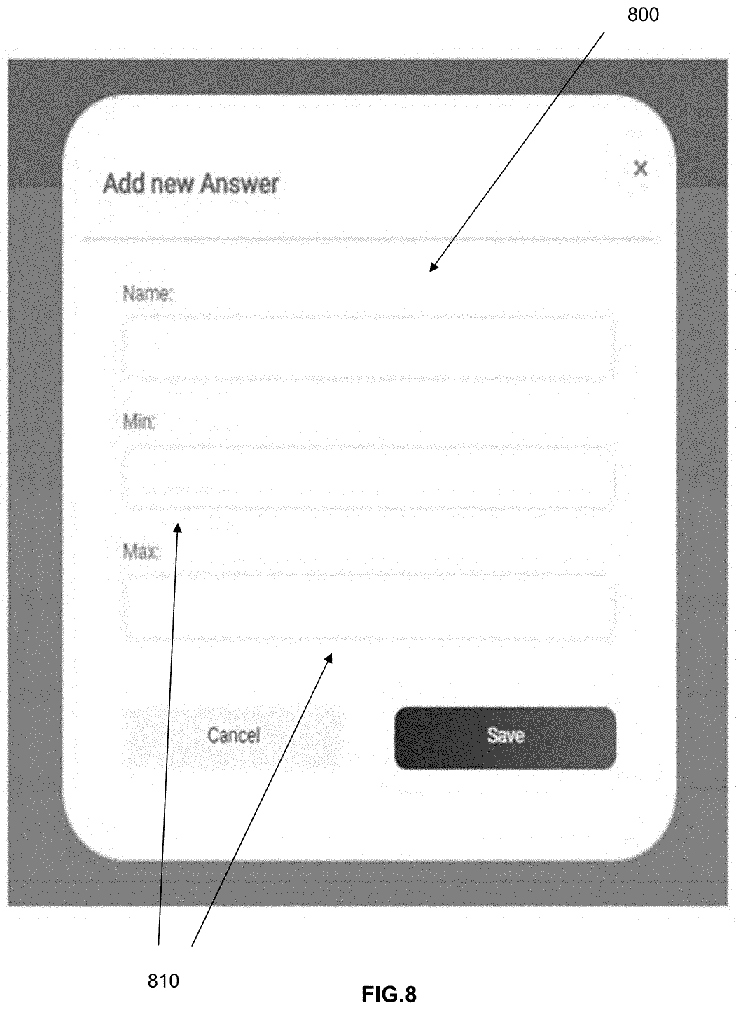

With reference to FIG. 8, in one embodiment, the client can then add answers 800 to the questions 700 (FIG. 7). In particular, the answers 800 are added by the client to avoid having the answer 800 used in multiple questions 700 and quotation templates 200. In another embodiment, the client can assign an input range 810.

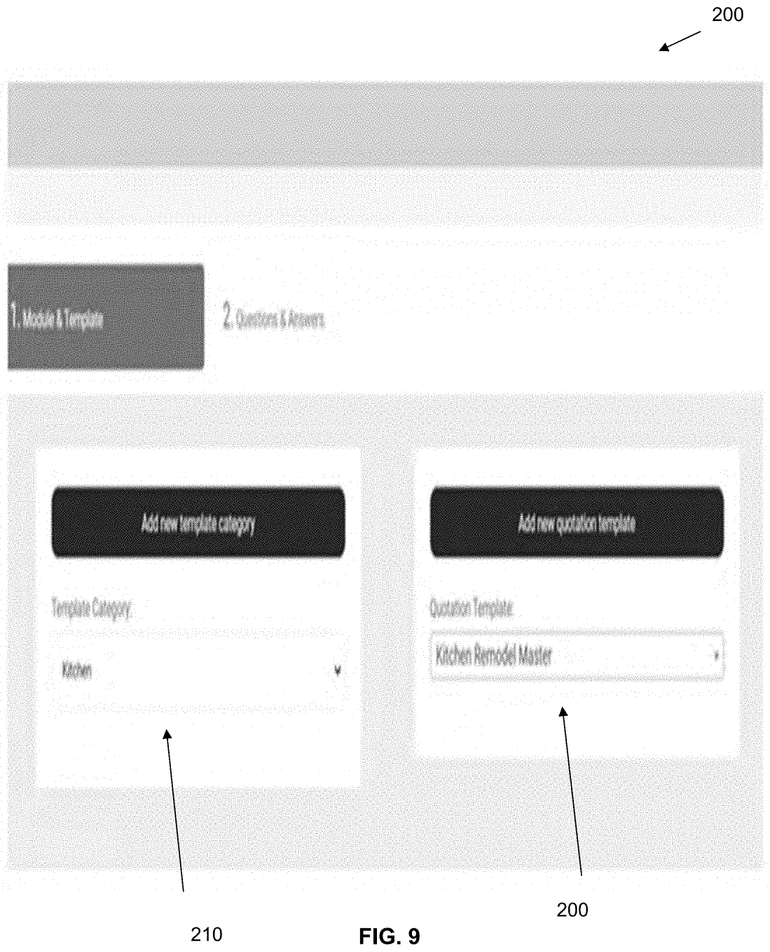

Once the template category 210, template sub-category 220, sections 510, questions 700, and answers 800 are created, the application server 120 is configured to allow the client to populate each quotation template 200. In one embodiment, as shown in FIG. 9, the application server 120 is configured to select the template category 210 (and the template subcategory) to filter down the correct quotation template 200 to work on.

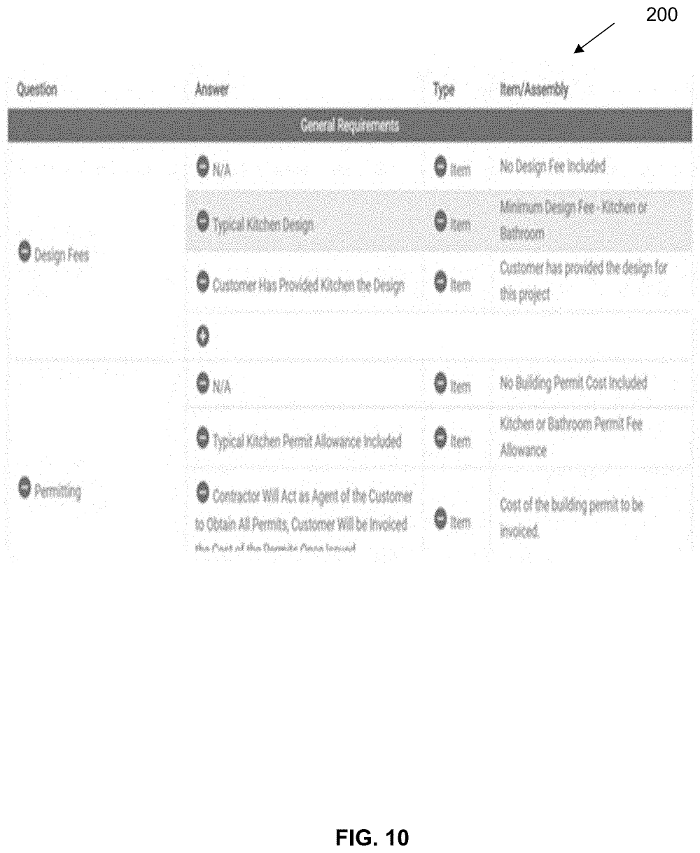

Once the application server 120 selects the template category 210 (and template sub-category) to filter down the correct template 200 to work on, as shown in FIG. 10, the application server 120 is configured to present the correct template 200 to the client so that the client can assign the proper questions, answers, and responses within the sections 510.

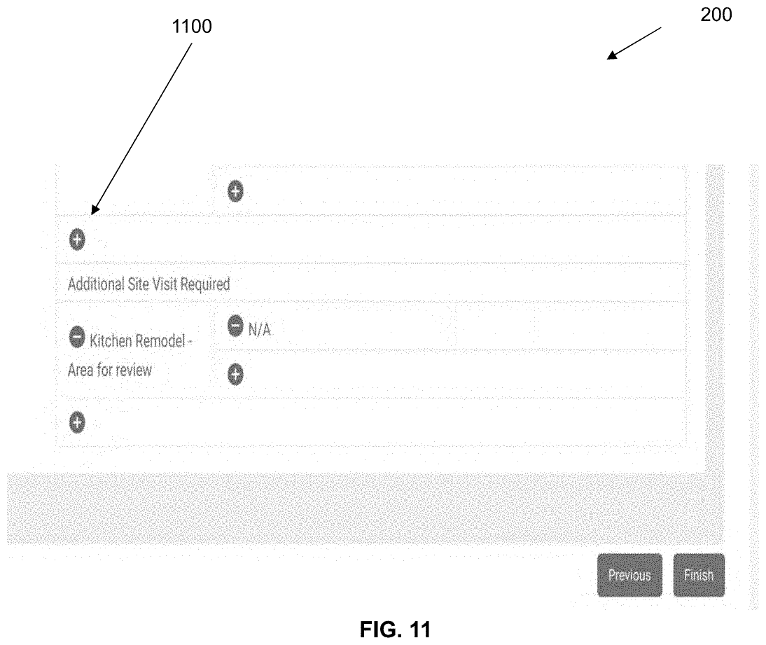

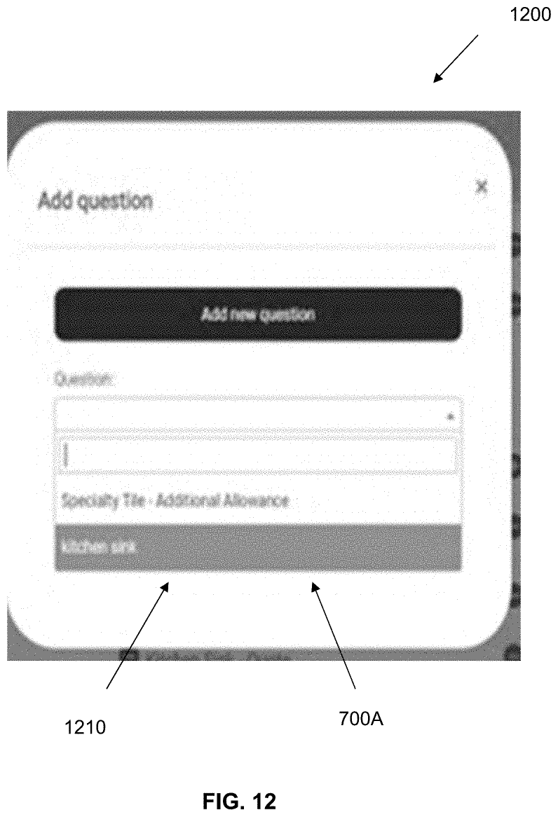

In one embodiment, as shown in FIG. 11, the application server 120 is configured to provide an add button 1100 in the question column. In one embodiment, upon the add button 1100 being selected by the client, the application server 120 is configured to present to the client a list of questions 700 assigned to that specific quotation template 200 (FIG. 12).

Upon presenting to the client a list of questions assigned to the template, as shown in FIG. 12, the application server 120 is configured to allow the client to prepare and present to the client a display 1200 that will allow the client to add an item and/or assembly to the question section of the quotation template. In one embodiment, the item “kitchen sink” 1210 has been added to the kitchen sink question section 700A of the quotation template.

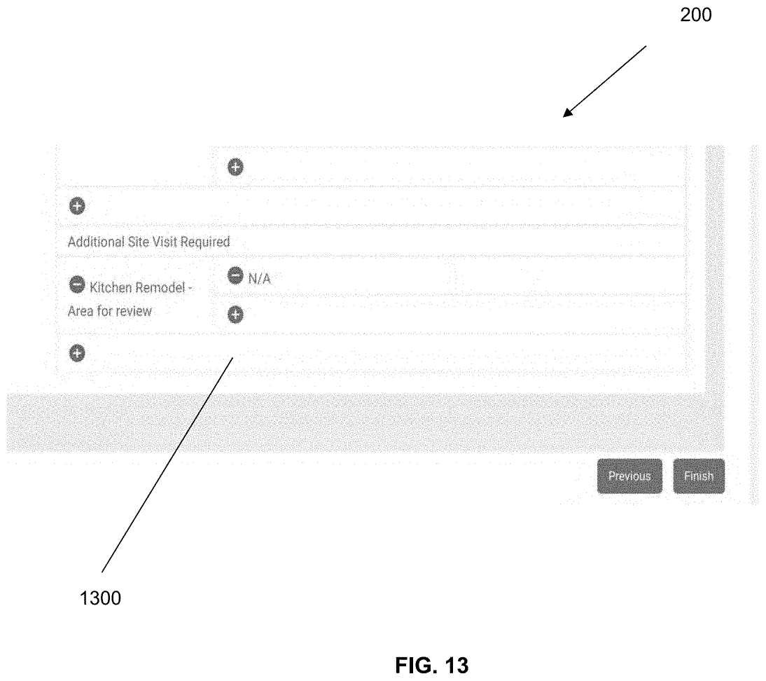

In one embodiment, as shown in FIG. 13, the application server 120 is configured to prepare and present on the quotation template 200 an add button 1300 in the question column. In one embodiment, upon the add button 1300 being selected by the client, the application server 120 is configured to add the item and/or assembly to the question section of the quotation template 200.

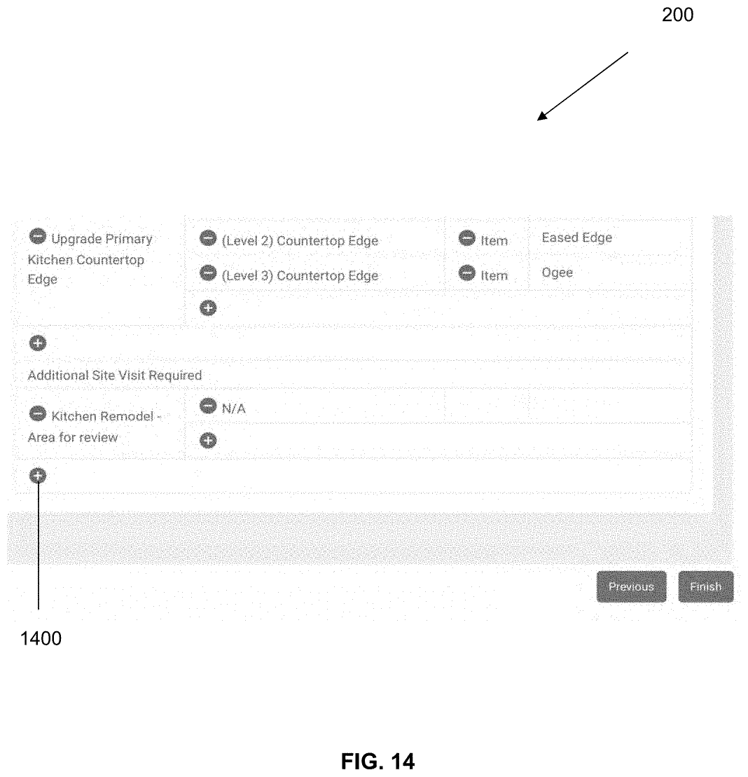

Upon the item and/or assembly being added to the question section of the quotation template 200, as shown in FIG. 14, in one embodiment, the application server 120 is configured to allow the client to select the add button 1400 in the answer column to present to the client a list of answers.

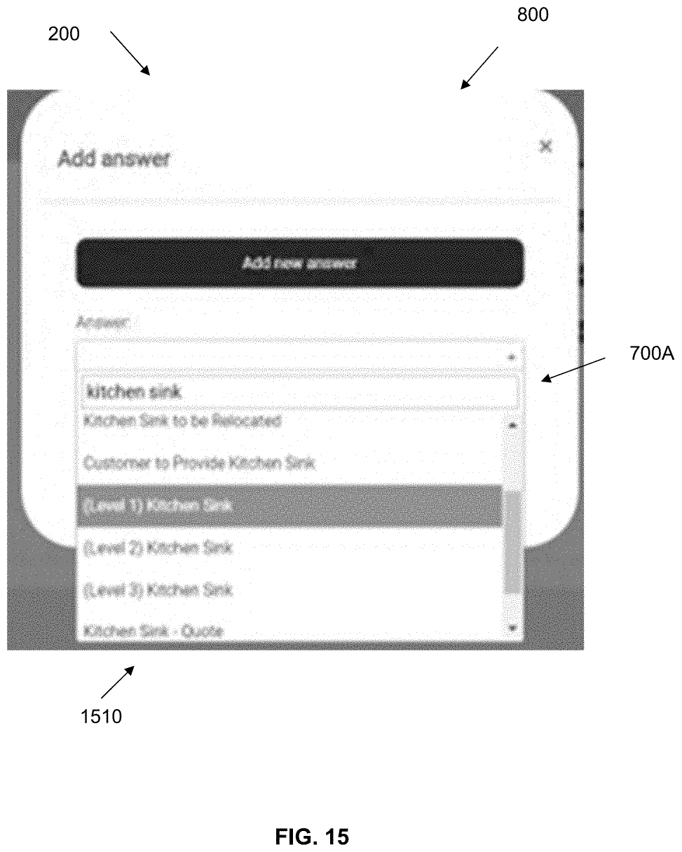

Upon presenting to the client a list of answers, as shown in FIG. 15, in one embodiment, the application server 120 is configured to prepare and present to the client a list of possible answers 1500 on the quotation template 200 for a specific question 700A. For example, as shown in FIG. 15, a list of three (3) possible answers 1510 (Level (1) Kitchen Sink, Level (2) Kitchen Sink, and Level (3) Kitchen Sink) have been presented to the client.

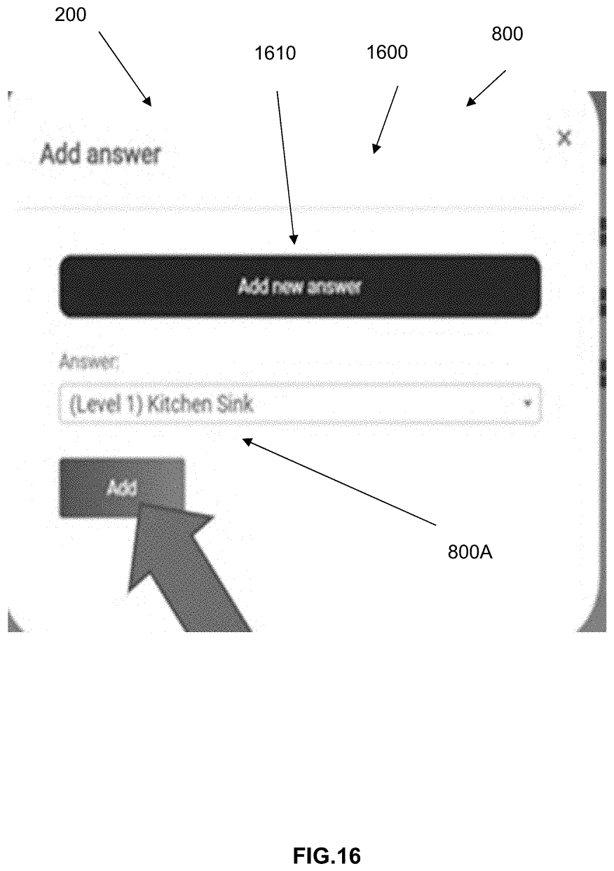

In one embodiment, as shown in FIG. 16, upon selecting an answer from the list of answers 800, the application server 120 is configured to prepare and present to the client a display 1600 that will allow the client to add the selected answer 800A to the answer window. For example, when the client selects the (Level 1) Kitchen Sink answer and clicks on the add button 1610, the application server 120 is configured to add the selected answer 800A to the Kitchen Sink question 700A.

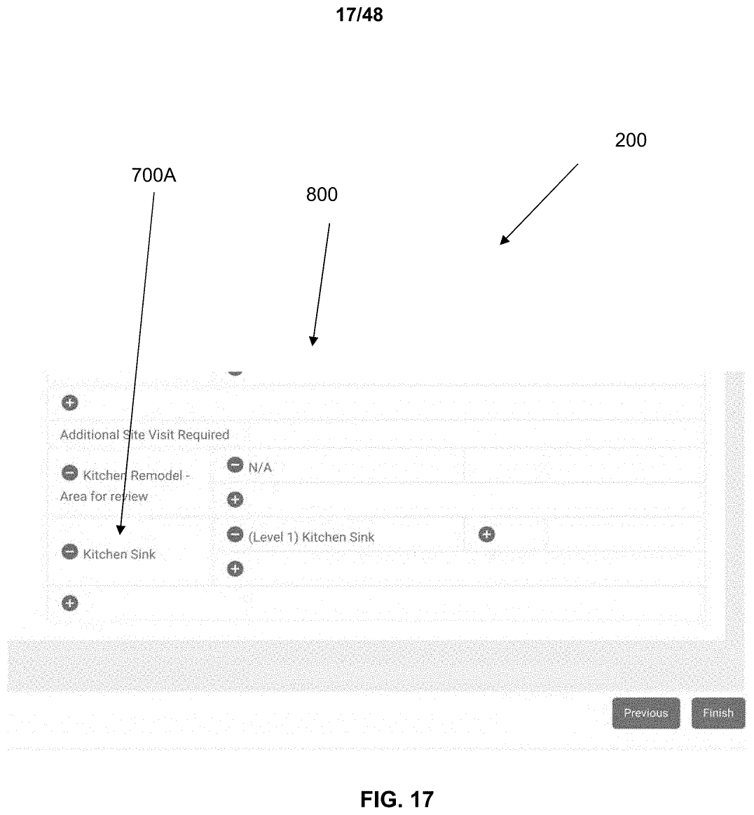

Once the answers 800 to the Kitchen Sink question 700A has been selected, in one embodiment, as shown in FIG. 17, the application server 120 is configured to add the selected to the question 700A (along with the selected answers 800) to the quotation template 200.

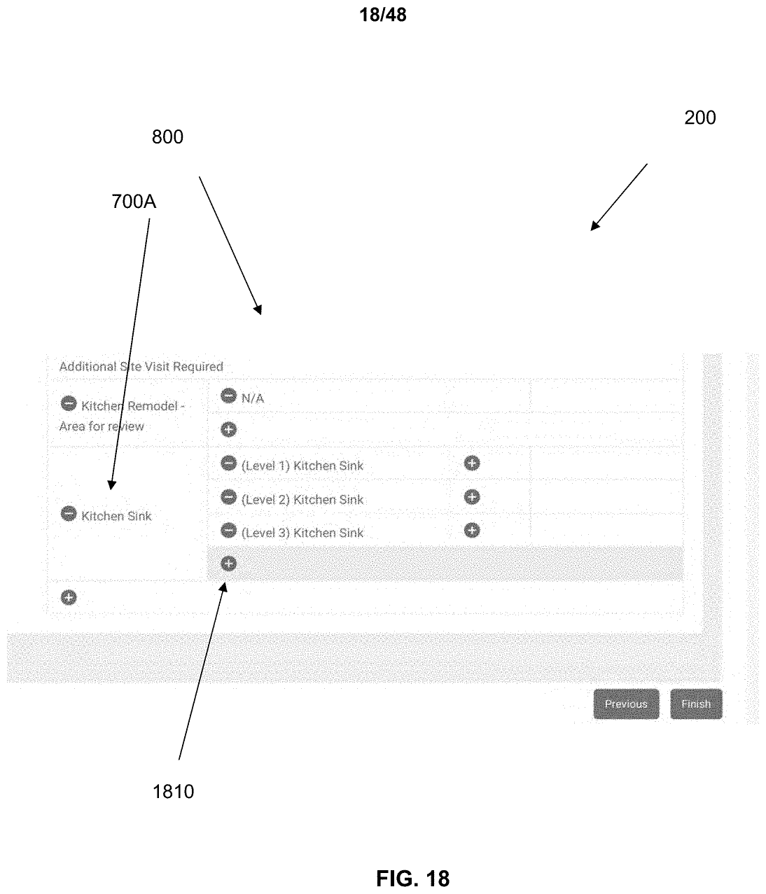

In another practical application, as shown in FIG. 18, the application server 120 is configured to add any other answers 800 that the client selects that are related to the question 700 to the quotation template 200. Furthermore, as shown in FIG. 18, when the client selects a “+” 1810 associated with a particular answer 800, the application server 120 is configured to allow the client to select the appropriate database response for subsequent programming of the answer 800.

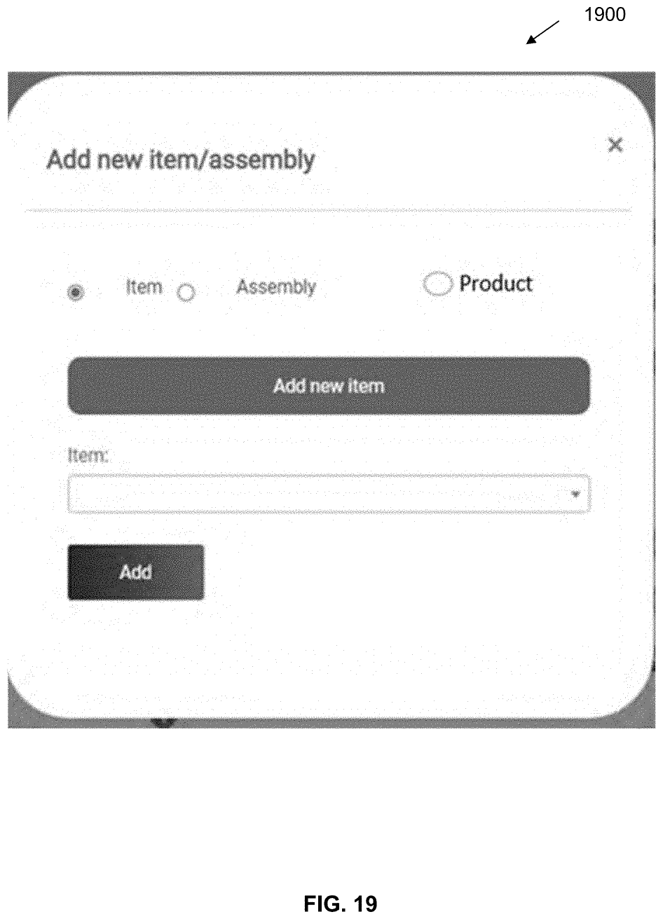

As shown in FIG. 19, in one embodiment, the application server 120 is configured to prepare and present to the client a display 1900 that will allow the client to select a response from one of the databases (item level, assembly level, or the product level). For example, as shown in FIG. 19, if the answer will require on a single item, then the only the item level will need to be queried in order to obtain the response for the answer.

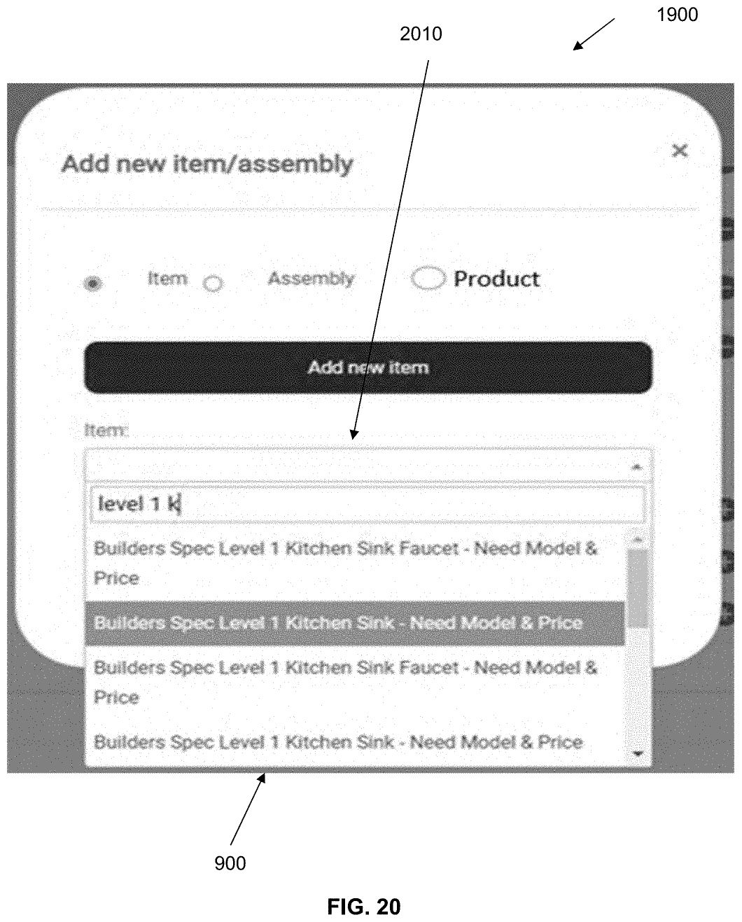

Upon selecting the item database, as shown in FIG. 20, the application server 120 is configured to prepare and present to the client a drop-down menu 2010 that allows the client to select the item stored the item level that most closely matches the answer (i.e., the response 900). In one embodiment, the selected item (response 900) already has information associated with it such as cost and item specification, as previously discussed. In this manner, if this response 900 is later selected by the end user, the application server 120 is configured to obtain this item information and present it to the end user.

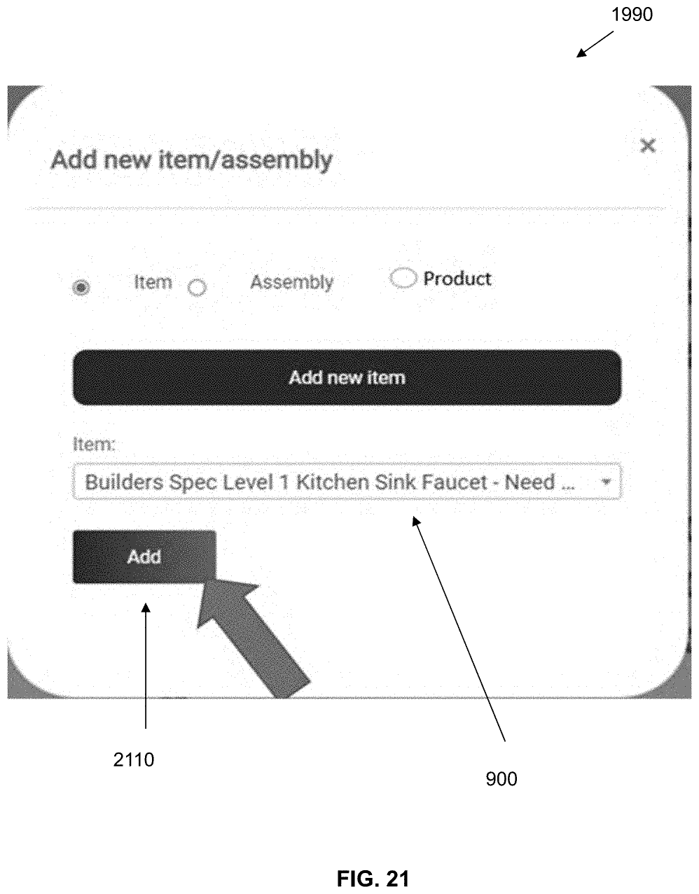

Once the client has selected the desired item (response 900) that most closely matches the answer, as shown in FIG. 21, in one embodiment, the application server 120 is configured to allow the client to add the selected item (response 900) to the item database by selecting the add button 2110.

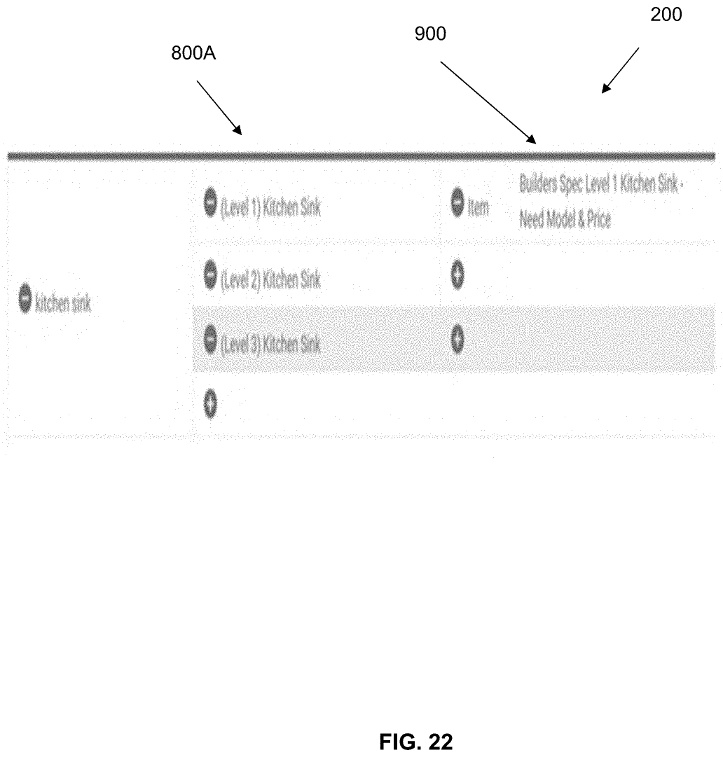

After the selected item (response 900) has been added to the item database, as shown in FIG. 22, the application server 120 is configured to add the response 900 to the first answer 800A in the quotation template 200.

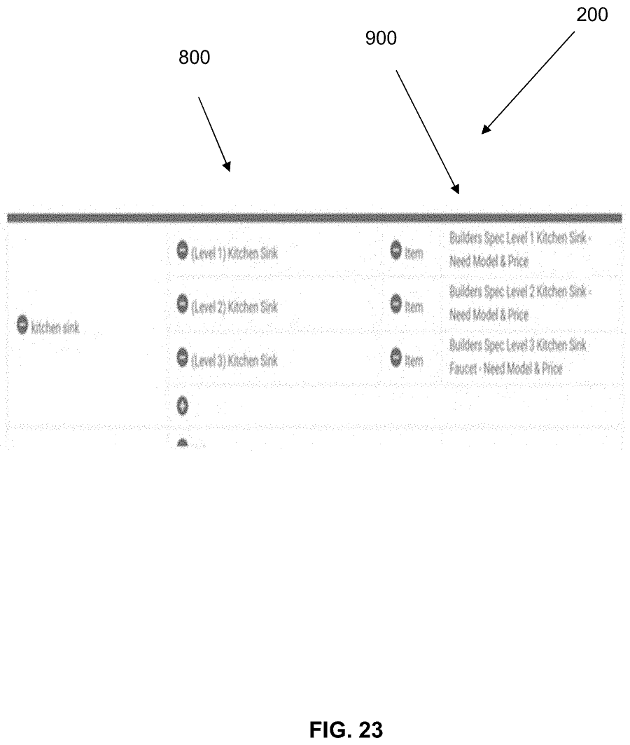

In one embodiment, the application server 200 is configured to allow the client to add the appropriate response 900 to the other answers 800 in the quotation template 200, as shown in FIG. 23. As further shown in FIG. 23, a particular response 900 can be associated with a specific item. In this manner, when the response 900 is selected, the client and/or the end user can be assured that only that specific item and the information associated with that item that is stored in the item database will be accessed, retrieved, and returned to the client and/or end user.

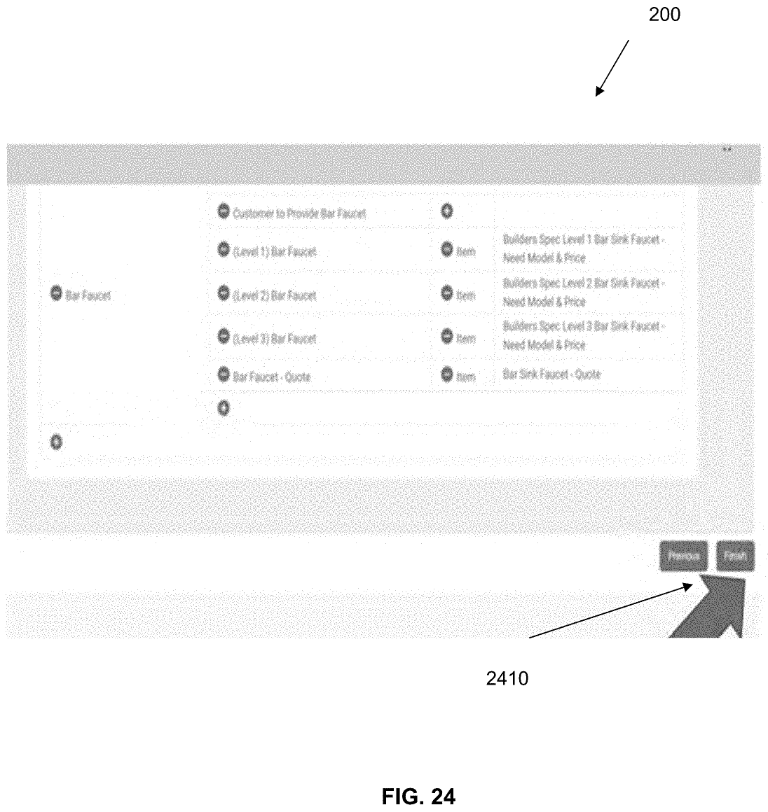

Once all of the appropriate responses 900 to the answers 800 have been added to quotation template 200, as shown in FIG. 24, the application server 120 is configured to allow the end user to select a “Finish Tab” 2410 which causes the quotation template 200 to be added to template database 130 (FIG. 1). In this manner, the quotation template 200 is now available to be selected by the client and/or end user when the end user initiates a client project quotation template.

### Item/Assembly/Product Database

Returning back to FIG. 1, with respect to item/assembly/product database 140, as discussed above, the item/assembly/product database 140 can also store additional information at the item level for generating reports such as vendor, selection information, accounting information, cost, job cost code, specification content, location tag, upgrade information, digital catalog controls, and content. In one embodiment, the item level of database 140 will include information, for example, that identifies the particular refrigerators and sinks by a particular item identifier to each of the different refrigerators and sinks (such as refrigerator1, refrigerator2, sink1, and sink 2).

In another embodiment, the item/assembly/product database 140 will also include an assembly level having data associated with the identification of the particular assembly such as an assembly number. The assembly level of database 140 will also include a price associated with the current price of the assembly. For example, the assembly level may include information that such assemblies are being offered by the client such as the installation of a kitchen sink and a countertop. In another embodiment, the assembly level stores groups of items from the item level of database 140 along with formulas that share a common takeoff quantity to create an assembly so multiple Items can be calculated at the same time. For example, the assembly level will include information that identifies the particular assembly by a particular assembly identifier (such as sink/countertop assembly1, sink/countertop assembly2, etc.).

In another embodiment, the item/assembly/product database 140 will also include a product level of database 140 having data associated with the identification of the particular product such as a product number. The product level will also include a price associated with the current price of the product. For example, the product level may include information that such products are being offered by the client such as the remodeling of a kitchen. In another embodiment, the product level stores estimates that represent a specific design, project type or option that consist of Items and assemblies. For example, the product level of database 140 will include information that identifies the particular product by a particular product identifier (such as kitchen remodel1, kitchen remodel2, etc.).

In another embodiment, a current price for each of the items, assemblies, and/or products can also be associated with the particular item, assembly, and/or product and will be stored in the item level, assembly level, and product level, respectively, of database 140. A unique aspect of the present invention is that the vendors who will be completing the end user's project will maintain a database 160 of the current prices of the items that vendor 150 will sell to the client that the client will need to complete the end user's project. In one embodiment, a machine learning model is configured to query the item/assembly/product database 140 and the vendor's database 160 to determine if a price for a particular item has changed. If the item price has changed, the machine learning model is configured to update the pricing data associated with that particular item in the item level of database 140. Also, the machine learning model is configured to update the pricing of any assemblies and/or projects that include that particular item in the assembly level and/or the project level, respectively, of database 140.

### Training of the Machine Learning Model

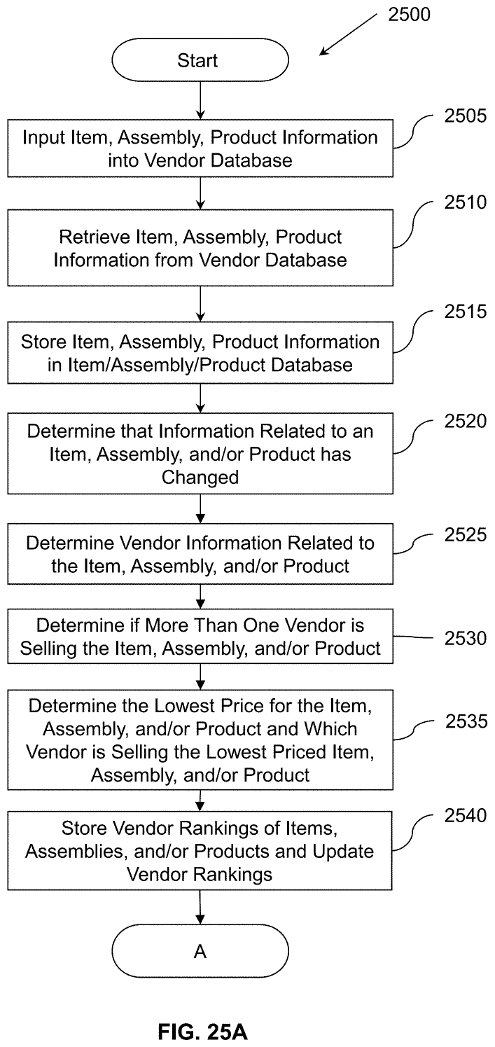

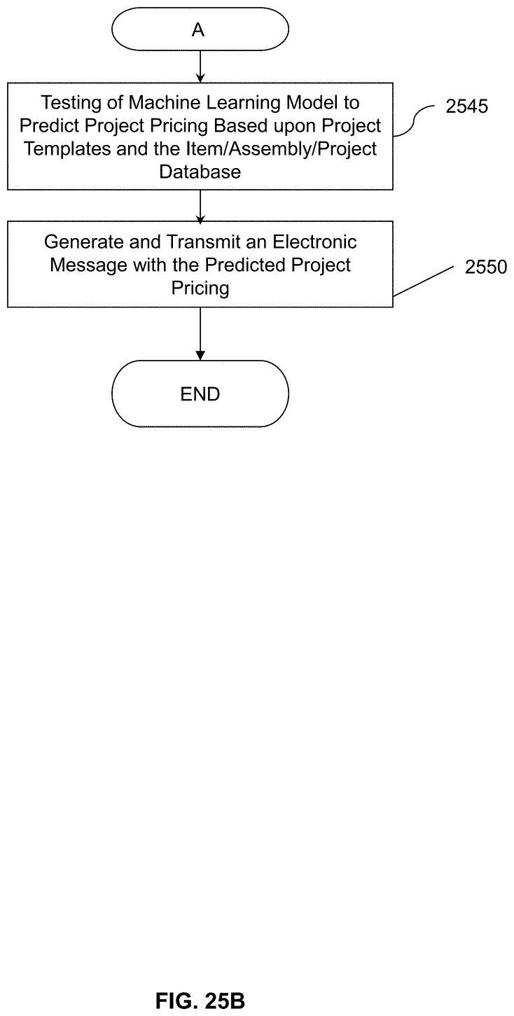

With reference to FIGS. 25A and 1B, one embodiment of a method 2500 for training a machine learning model using project templates and an item/assembly/project database 140 (FIG. 1) to predict a project pricing is illustrated. The method 2500 is performed by at least a processor of a computer system that accesses and interacts with memories and/or data storage devices. For example, the processor at least accesses and reads/writes data to the memory and processes network communications to perform the actions of FIGS. 25A and 25B.

To train a neural network model such as a machine learning model to predict a project pricing by using project templates and an item/assembly/project database, attention is directed to FIGS. 25A and 25B. In one embodiment, the present technique trains a machine learning model (including a neural network) with a collection of known project templates which include known items and assemblies related to the known project. In another embodiment, the known project templates also include at least one customized known question and answer related to the known item, known assembly, and/or known project wherein a known answer is to be selected by the end user (i.e., customer). Based upon the known answer selected by the end user, the machine learning model can then interact with the item/assembly/project database to predict the pricing associated with completing the project.

The machine learning model is used in one embodiment since the machine learning model can learn from its own performance and modify its own predictions. In particular, the pricing associated with the completed project can be updated to provide current, market-based pricing. The machine learning model can obtain the current, market-based pricing and determine which vendor is providing the best pricing (i.e., lowest price) for the completion of the project.

In another embodiment, the machine learning model can receive information related to item pricing, assembly pricing, and/or project pricing from the item/assembly/project database. The machine learning model is configured to identity a particular item and/or assembly related to a project and determine if the pricing related to the particular item and/or assembly has changed. If the pricing related to the particular item and/or assembly has changed, the machine learning model is configured to update the pricing related to the particular item and/or assembly.

In another embodiment, a current price for each of the items, assemblies, and/or products can also be associated with the particular item, assembly, and/or product and will be stored in the item/assembly/product database 140. A unique aspect of the present invention is that the vendors 150 who will be completing the project will maintain a database of the current prices of the items that vendor 150 will sell to the client that the client will need to complete the end user's project. The machine learning model is configured to query the item/assembly/product database 140 and the vendor's database 160 to determine if a price for a particular item has changed. If the item price has changed, the machine learning model is configured to update the pricing data associated with that particular item. Also, the machine learning model is configured to update the pricing of any assemblies and/or projects that include that particular item.

As shown in FIG. 25A, at block 2505, the method 2500 is initiated when information related to a specific item, assembly and/or product are entered into the item level, assembly level, and/or product level of database 140 (FIG. 1). As discussed above, this information for the item, assembly, and/or product can be related to vendor, selection information, accounting information, vendor delivery of the item, cost, job cost code, specification content, location tag, upgrade information, selection information, digital catalog controls, content, or the like.

As discussed above, in one embodiment, the vendor 150 (or a trusted third party) should maintain up-to-date information related to the item, assembly, and/or product that the vendor is selling. This up-to-date information is stored in the vendor database 160.

In block 2510, the machine learning model is configured to interact with the vendor database 160 and retrieve the current information related to the items, assemblies, and/or products that the client purchases from the vendor 150.

In block 2515, the machine learning model is configured to store the retrieved item, assembly, and/or product information in the item/assembly/product database 140. In one embodiment, as discussed above, the machine learning model is configured to store item information in the item level of database 140. Also, the machine learning model is configured to store the assembly information in the assembly level of database 140. Finally, the machine learning model is configured to store the product information in the product level of database 140.

In block 2520, the machine learning model is configured to monitor the databases 140 and 160 to determine if the information for a particular item, assembly, and/or product has changed. In one embodiment, the machine learning model has determined that the price of a particular item has increased since the price for the particular item in database 160 is now higher than the price for the item in database 140.

In block 2525, if the machine learning model has determined that the information related to the item, assembly, and/or product has changed (i.e., the price of the item has increased), the machine learning model is configured to determine the item, assembly, and/or product in which the information has changed (i.e., the item price has increased) and then determine what vendor 150 is selling that particular item.

In block 2530, the machine learning model is configured to determine if more than one vendor 150 is selling the particular item, assembly, and/or product.

In block 2535, if the machine learning model determines that more that more than one vendor 150 is selling the particular item, assembly, and/or product, the machine learning model is configured to determine which price for the particular item, assembly, and/or product is the best (i.e., lowest) and which vendor 150 is selling that lowest price item, assembly, and/or product. In one embodiment, the machine learning model is configured to learn and define (i.e., rank) the items, assemblies, and/or products based upon desired information (such as the price of the item, assembly, and/or product) and associate a particular vendor 150 with that ranked item. In this manner, the machine learning model is learning to also rank the vendors 150 depending upon the information related to the item, assembly, and/or product such as the price of the item, assembly, and/or product associated with that vendor 150.

As will be discussed in greater detail later, the item, assembly, and/or product information are used to train the neural network of the machine learning model. Then the machine learning model may be tested with a request for a response 900 related to a quotation template 200 to determine the item, assembly, and/or product information necessary to provide the response 900 to the answer 800. If the response 900 involves providing information (i.e., pricing) that involves at least two (2) vendors 150 being able to provide the item, assembly, and/or product to the client and/or end user, in one embodiment, the machine learning model is trained to rank the pricing and/or the vendors 150 and provide the client and/or end user with the pricing and/or vendor 150 selling the item, assembly, and/or product at the lowest price.

In another embodiment, the machine learning model is trained to review vendor information and determine which of the vendors 150 is a “preferred vendor” and which of the vendors 150 is a “non-preferred vendor”.

In block 2540, the machine learning model is configured to store the pricing and/or vendor rankings of the items, assemblies, and/or products and update the pricing and/or vendor rankings depending upon the nature of the changed information related to the particular item, assembly, and/or product.

In block 2545 (FIG. 25B), the machine learning model may be tested for how accurately it predicts project pricing based upon using project templates and an item/assembly/project database. The machine learning model is expected to generate a best (i.e., lowest) price for the item, assembly, and/or project response requested in a project template and, optionally, generate a notification for the client and/or end user as to whether the vendor selling the item, assembly, and/or project is a “preferred” or “non-preferred” vendor.

In block 2550, the system 100 is configured to generate and transmit an electronic message with the predicted project pricing to the client, end user, and/or the vendor.

A practical application of the present invention is the use of the machine learning model to select the vendor 150 who will provide the best price (i.e., lowest) for a particular item and/or provide the best service in relation to a particular item, assembly and/or product. In particular, as discussed above, the machine learning model is configured to update the pricing of any assemblies and/or projects that include that particular item. In this manner, if a particular item is requested by a client, the machine learning model is configured to query the item database and retrieve information related to the particular item such as vendor, selections, accounting information, vendor delivery of the item, cost, job cost code, specification content, location tag, upgrade information, selection information, digital catalog controls, and content. The machine learning model is then configured to determine the lowest cost for the particular item and return to the client and/or end user the lowest cost for that item and the vendor 150 associated with the lowest cost. The client and/or end user can then determine if the client and/or end user wish to purchase the particular item from the vendor 150.

### Testing to Predict Project Pricing Using Quotation Templates and Item/Assembly/Project Database

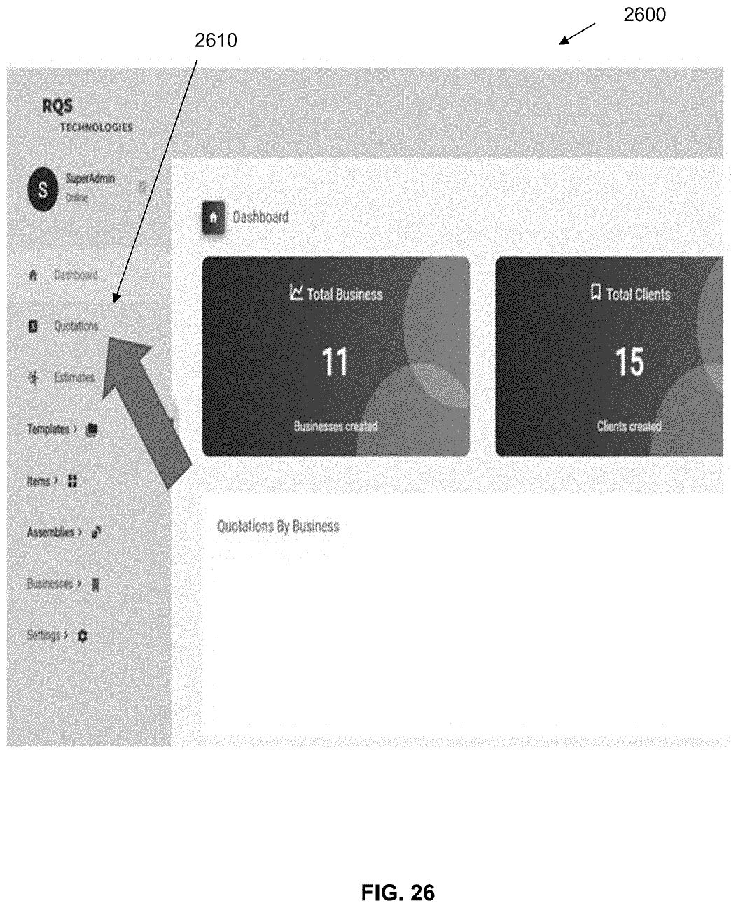

To begin a test, for example, as shown in FIG. 26, a client and/or end user interacts with the application server 120 through remote device 110 (FIG. 1), as discussed above. In particular, the client and/or end user opens an application on the remote device 110 or interacts with a browser on remote device 110 to open an application. In one embodiment, the application 2600 will access a quotation template function 2610 on the application. In one embodiment, upon accessing the application, the application will interact with the application server 120 and the application server 120 is configured to present to the client and/or end user a home screen 2600 which displays a new quotation, as shown in FIG. 26. Furthermore, as shown in FIG. 26, to start a new quotation, the client and/or end user should select the quotation tab 2610.

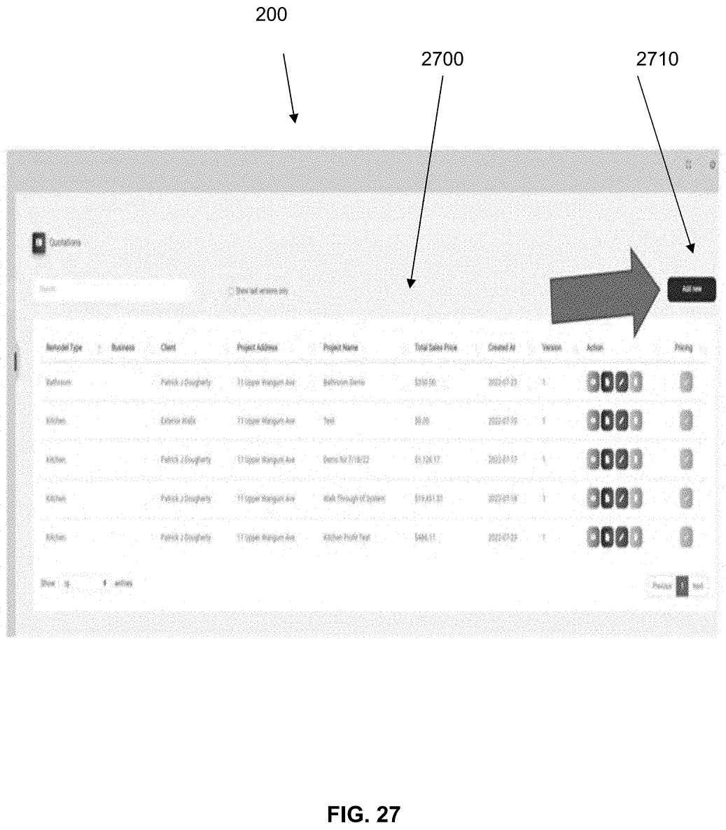

As shown in FIG. 27, after selecting the quotation tab, the application server 120 is configured to prepare and present to the client and/or end user a quotations section 2700 where any pre-existing quotation templates 200 are displayed. Furthermore, as shown in FIG. 27, if the client and/or end user want to begin a new quotation template 200, the client and/or end user can select the “add new” button 2710 to open a new quotation template 200.

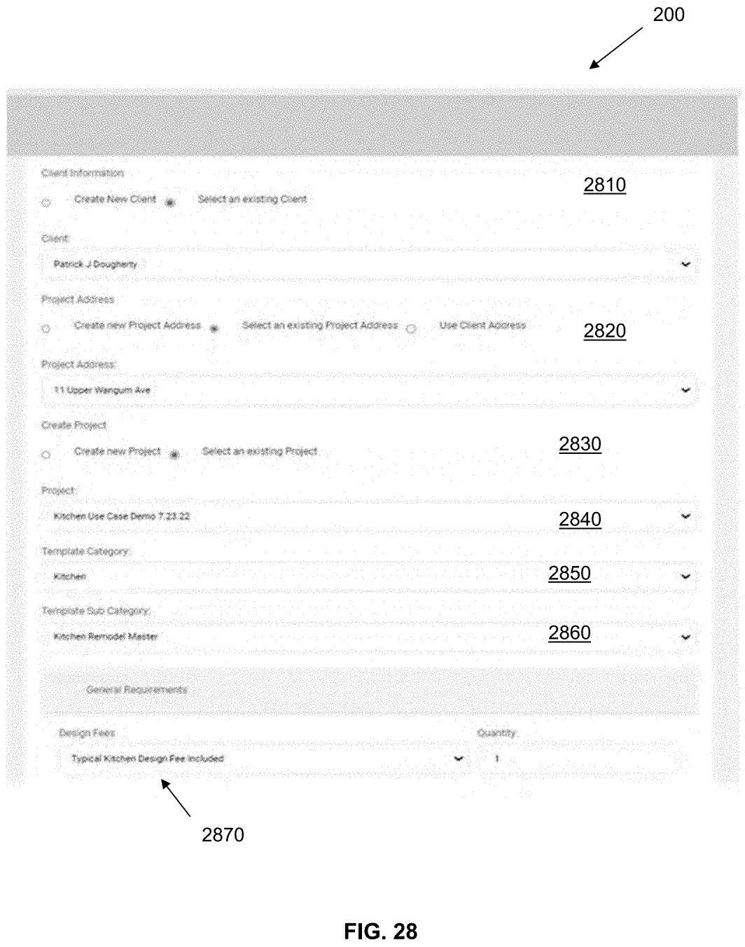

Upon selecting the add new button 2710, as shown in FIG. 28, the application server 120 is configured to prepare and present to the client and/or end user a new quotation template 200. In one embodiment, the new quotation template 200 may include, but is not limited to, a client information section 2810, a project address section 2820, a create project section 2830, a project section 2840, a template category section 2850, a template subcategory section 2860, and a design fee section 2870.

In one embodiment, as shown in FIG. 28, since the new quotation template 200 is related to the client in FIG. 27, the new quotation template 200 of FIG. 28 will also include the client information, client, project address, and project name from FIG. 27.

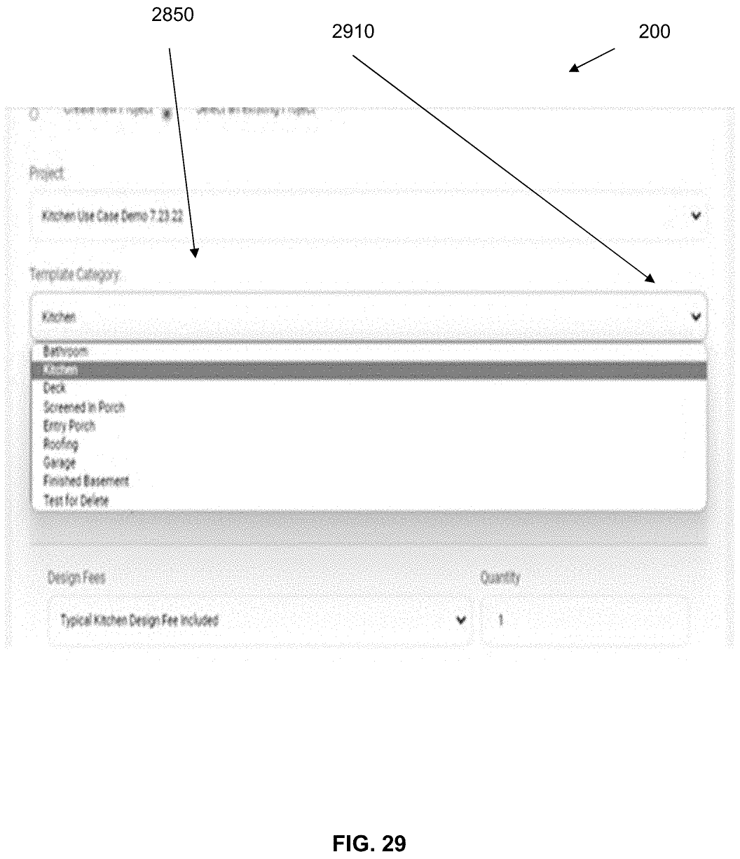

As shown in FIG. 29, when the client and/or end user interacts with the template category section 2850 and selects the kitchen in the drop-down menu 2910, the kitchen is selected. In one embodiment, assume that the kitchen is selected because the end user desires to have the client perform remodeling on the end user's kitchen.

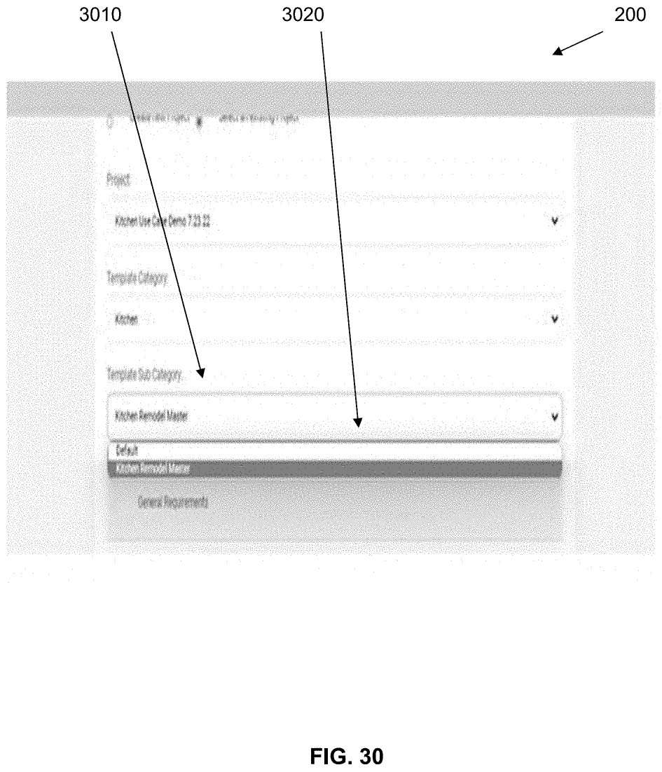

As shown in FIG. 30, by selecting the quotation template subcategory section 2860 (FIG. 28), sections, questions, and answers for this project type only will appear in the questions and answers drop-down menu. In one embodiment, by selecting the kitchen remodel master section 3010, the application server 120 is configured to prepare and present to the client and/or end user a drop-down menu 3020. In another embodiment, the client and/or end user can then select the kitchen remodel option in the drop-down menu 3020, as shown in FIG. 30.

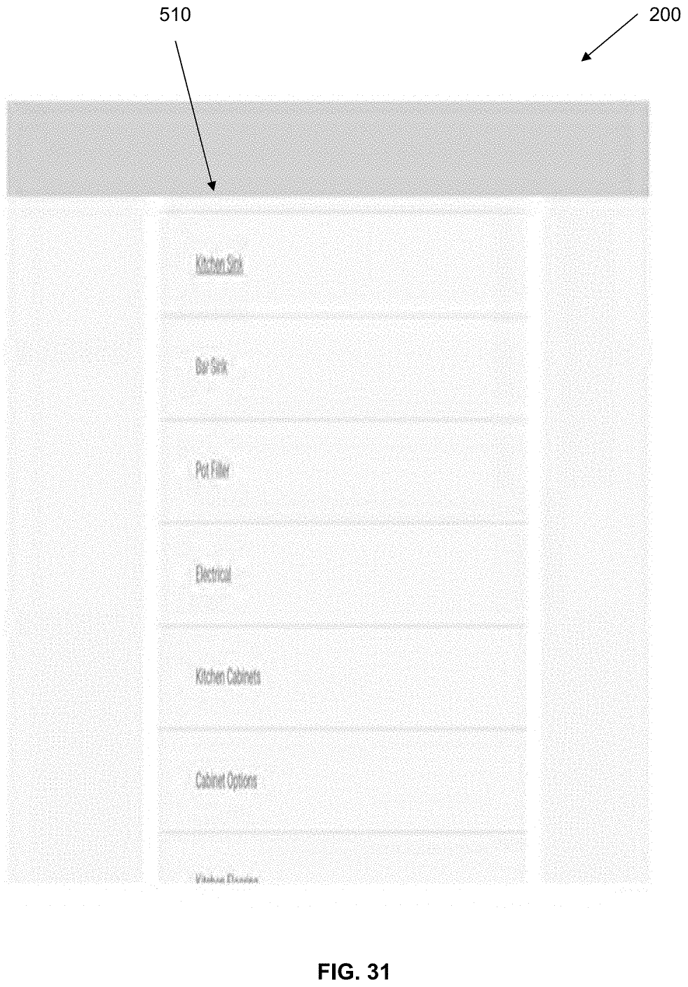

As shown in FIG. 31, the client and/or end user can then begin working through the sections 510 of the quotation template. In one embodiment, the client and/or end user can review the questions, select the applicable answers, and input a quantity, as needed, for the specific project they are working on. While FIG. 31 illustrates a plurality of possible sections 510 that could be included in a quotation template 200, other sections 510 can also be included depending upon the needs of the client and/or the end user. For example, if the client is in the business of building/remodeling automobiles, the sections 510, questions, answers, and responses can be customized to fit that client's business needs.

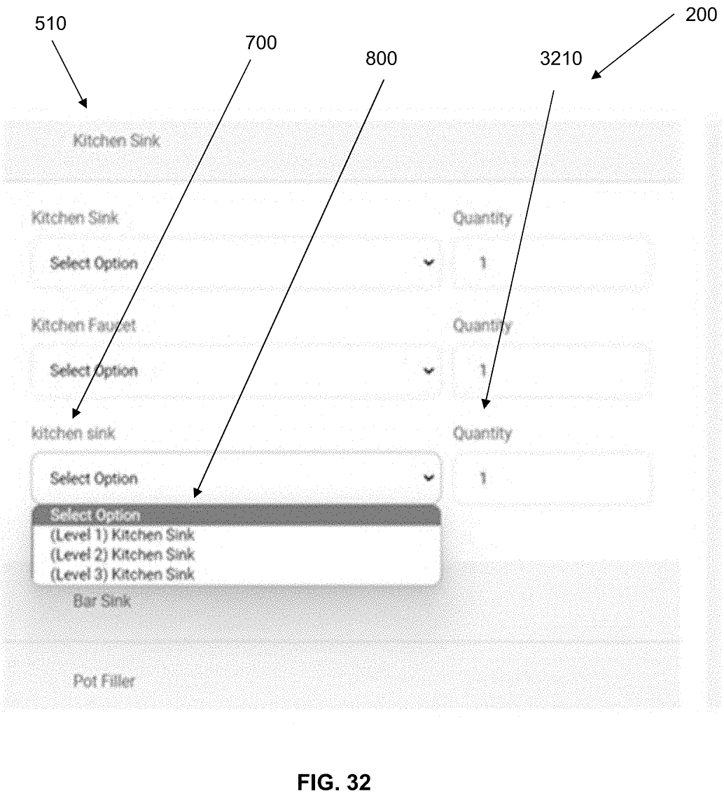

As shown in FIG. 32, once the client and/or end user selects a particular section, the application server 120 is configured to prepare and present to the client and/or end user a drop-down menu that shows the questions that are associated with (nested in) a particular section. In one embodiment, the questions are related to the level of sink that the client offers so that the end user can pick the desired sink level. It is to be understood that sink level generally refers to the style and quality of the sink with a level 1 sink being of a higher quality than a level 4 sink.

Furthermore, as shown in FIG. 32, the client and/or end user has selected a question 700 in the section 510. In one embodiment, the client and/or end user has selected the (Level 1) Kitchen Sink answer 800 and selected a quantity of one (1) 3210.

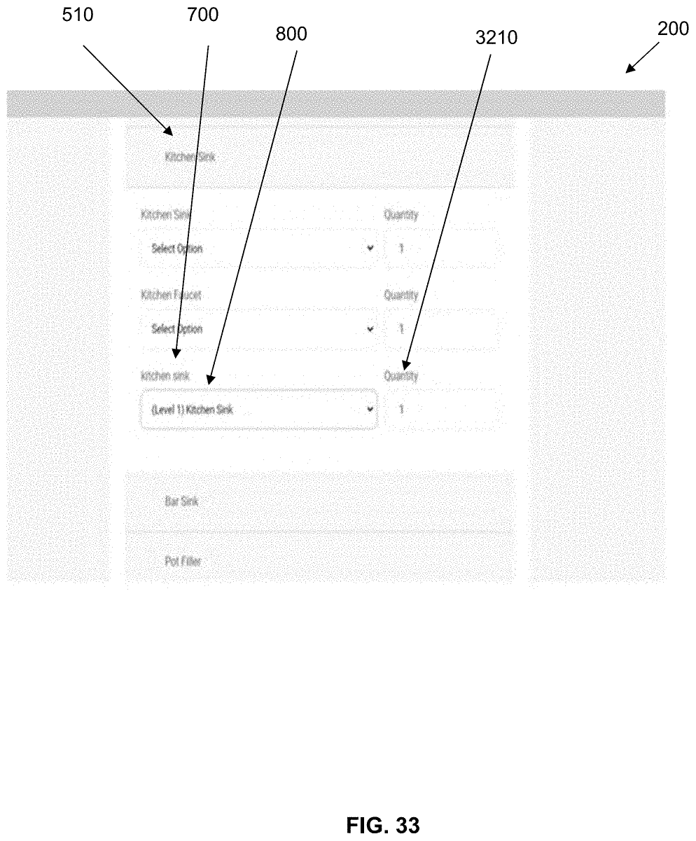

As shown in FIG. 33, upon selecting the question 700 in FIG. 32, the application server 120 is configured to add the selected question 700 to the quotation template 200 along with the quantity 3210 related to the question. In one embodiment, the application server 120 is configured to prepare and present to the client and/or end user the quotation template 200 with the question 700 added to the section 510. In this instance, the (Level 1) Kitchen Sink answer 800 and quantity 3210 of one (1) have been added to the quotation template 200.

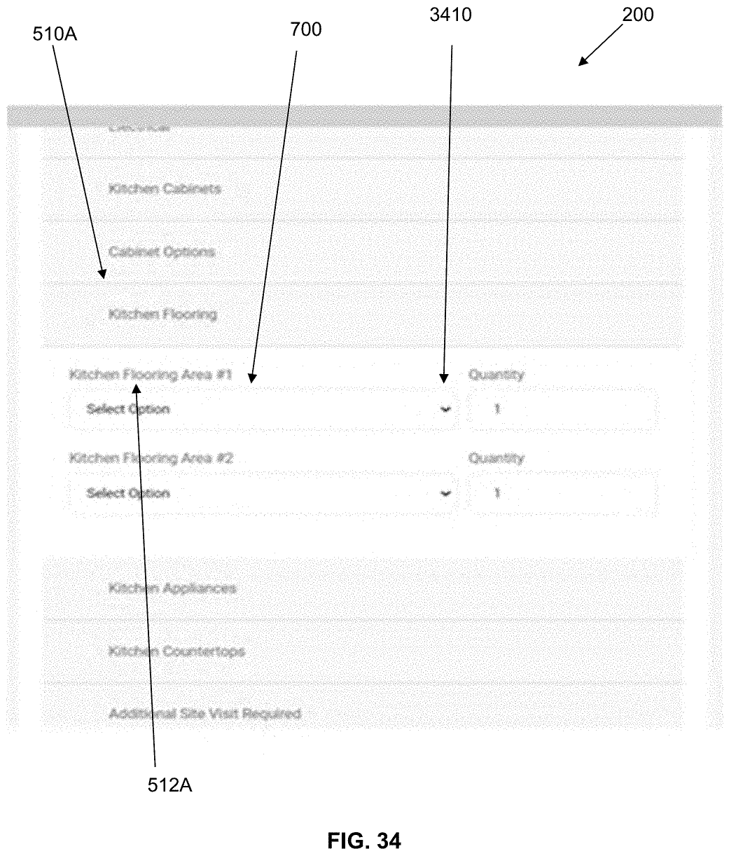

With respect to FIG. 34, the client and/or end user can also select a section 510 that may include an assembly (i.e., involve more than one item). In one embodiment, the client and/or end user has selected a kitchen flooring section 510A. Upon selecting the kitchen flooring section 510A, the application server 120 is configured to retrieve and present to the client and/or end user a plurality of drop-down menus 3410 that show the questions 700 that are associated with (nested in) a particular sub-section 512A. In one embodiment, the sub-sections 512A are related to kitchen flooring areas #1 and #2. It is to be understood that kitchen flooring areas generally refer to the style and quality of the flooring that is to be installed in a particular area such as a kitchen.

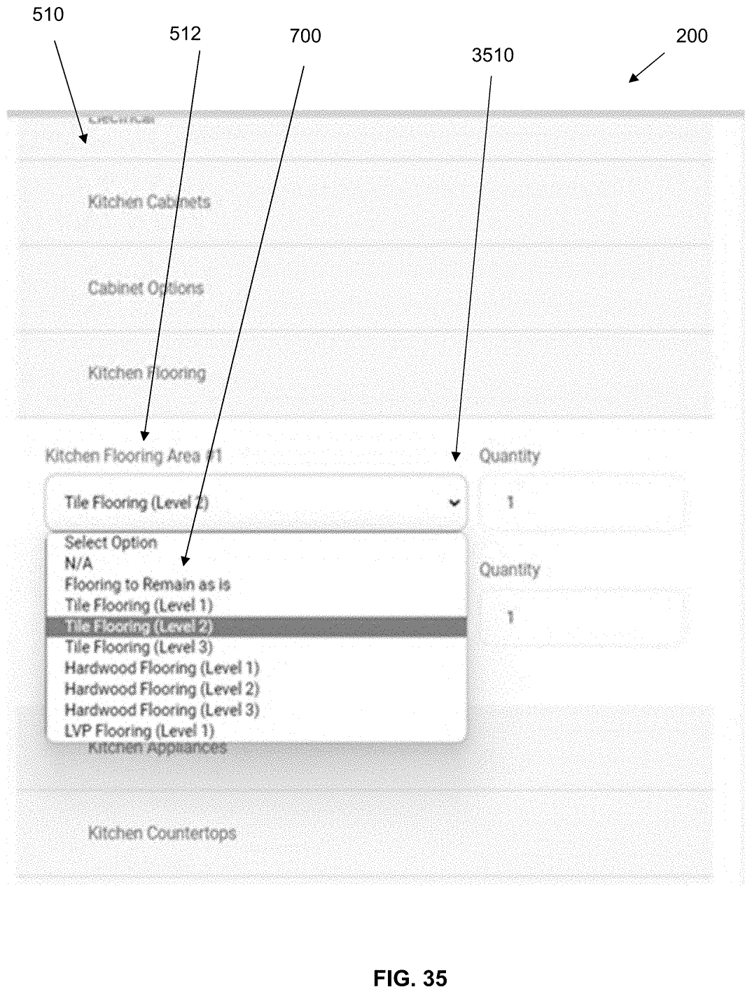

As shown in FIG. 35, once the client and/or end user selects a particular sub-section 512, the application server 120 is configured to prepare and present to the client and/or end user a drop-down menu 3510 that shows the questions 700 that are associated with (nested in) a particular sub-section 512. In one embodiment, the questions 700 are related to the tile flooring level that the client offers so that the end user can pick the desired flooring level such as tile flooring, hardwood flooring, or the like. It is to be understood that flooring level generally refers to the style and quality of the flooring with a level 1 flooring being of a higher quality than a level 2 flooring level.

Furthermore, as shown in FIG. 35, the client and/or end user has selected a question 700 in the sub-section 512. In one embodiment, the client and/or end user has selected the Tile Flooring (Level 2).

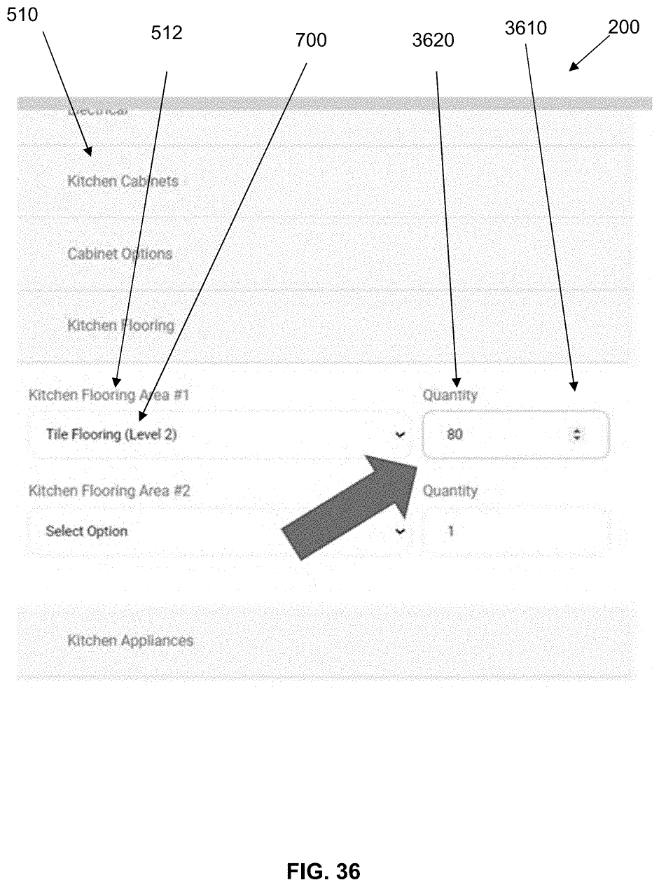

Once the client and/or end user has selected the question in the sub-section 512, as shown in FIG. 36, the client and/or end user should then select the quantity 3610 of the question 700. In one embodiment, the application server 120 is configured to prepare and present to the client and/or end user a menu 3610 that allows the client and/or end user to select the quantity 3620 of the question 700 in the sub-section 512. For example, as shown in FIG. 36, the client and/or end user has interacted with the menu 3610 to select the quantity 80.

Another unique aspect of the present invention is that the quotation template 200 is configured to allow the client and/or end user to simply input a quantity 3620 into the quantity portion of the quotation template 200 without having to specify if the quantity 3620 is a volume (i.e., gallons of paint), a length (i.e., linear feet of lumber), an amount (i.e., a number of nails), an area (i.e., square feet of tile), or the like.

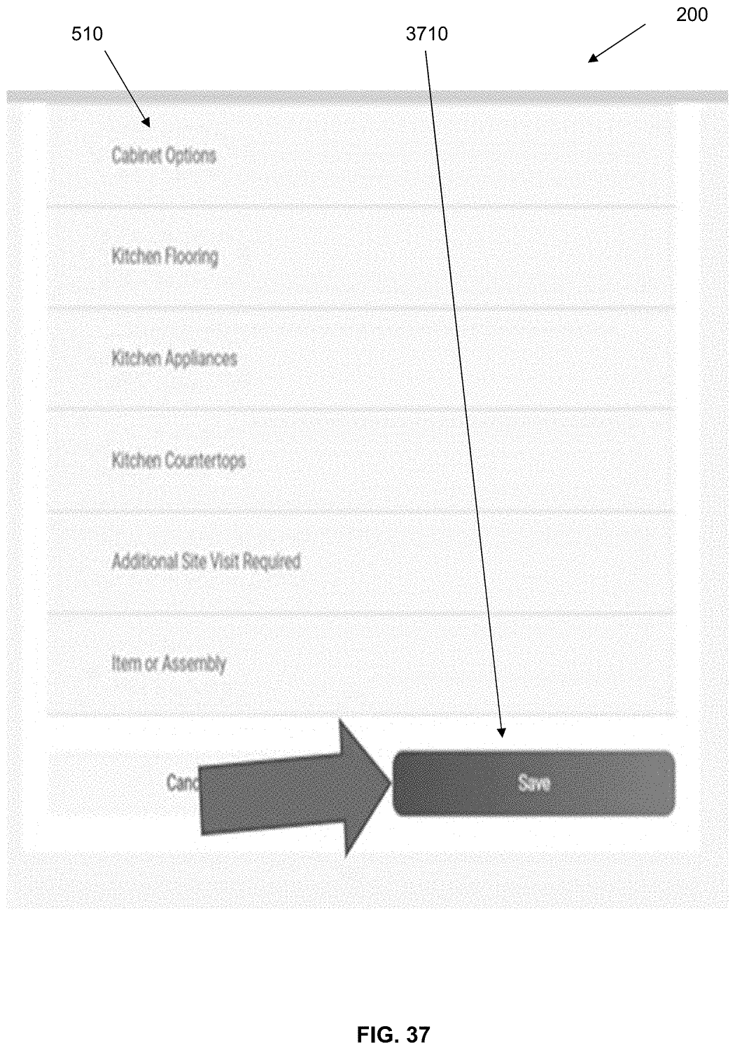

It is to be understood that the client and/or end user will review each section 510 of the quotation template 200 that is applicable to the end user's project. The client and/or end user should then review each question 700 related to the section 510 (an any sub-sections 512) that are also relevant to the end user's project. Once all the relevant sections 510 (and sub-sections 512) have been reviewed and the relevant questions 700 in those sections 510 (and sub-sections 512) have been answered, as shown in FIG. 37, the client and/or end user can save the quotation template 200 for the end user's project by clicking on the save button 3710 on the quotation template 200. Once the save button 3710 has been clicked, the application server 120 is configured to save all the information on the quotation template 200 and store the end user's quotation template 200 in the template database 130.

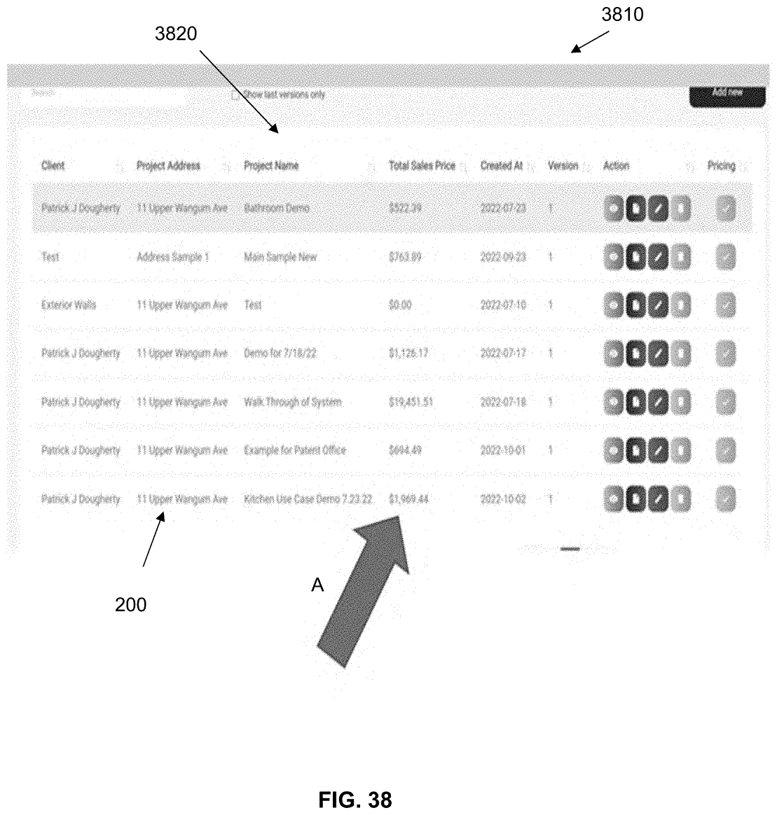

Once the completed quotation template 200 has been saved, as shown in FIG. 38, the application server 120 is configured to prepare and present to the client and/or end user a display 3810 of end user reports 3820 that include, among other things, the costs associated with completing the end user's project.

Regarding the costs associated with completing the end users project, as discussed above, the machine learning model is configured to determine the best (i.e., lowest) cost associated with a particular item, assembly, and/or project. In one embodiment, if a particular item is requested by a client, the machine learning model is configured to query the vendor database and the item database and retrieve information related to the particular item such as vendor, selection information, accounting information, vendor delivery of the item, cost, job cost code, specification content, location tag, upgrade information, digital catalog controls, and content. The machine learning model is then configured to determine the lowest cost for the particular item and return to the client the lowest cost for that item and the vendor associated with the lowest cost. The client can then determine if the client wishes to purchase the particular item from the vendor. In another embodiment, the machine learning model is configured to perform the same or similar cost analysis with respect to any assemblies that are to be included in the project.

In view of the above, the total sales price (as designated by arrow A in FIG. 38) should include all the up-to-date costs and fees associated with completing the end users project, as determined by the machine learning model.

While the end user report 3820 is useful in providing the basic, current costs and fees to complete the end user's project, in another practical application, the present invention is also capable of preparing and presenting to the client and/or vendor the costs, fees, item information, and assembly information needed for the vendor and the client to complete the end users project. In one embodiment, the vendor and/or client will need to know, for example, what kind of sink (and how many sinks) will be needed for the end user's project. Also, the client and/or the vendor will also need to know what kind of flooring and the amount of flooring (i.e., square feet of tile) are going to be installed in the end user's project. This information is important to the vendor since the vendor needs to know if these items and/or assemblies are on hand in the vendor's inventory or if the vendor needs to order these items and/or assemblies. Similarly, this information is important to the client since the client will be responsible for completing the end user's project and the client needs to know what items and/or assemblies will be needed to complete the project. Furthermore, this information is important to the client since the client may need to employ other employees/sub-contractors to complete the end user's project.

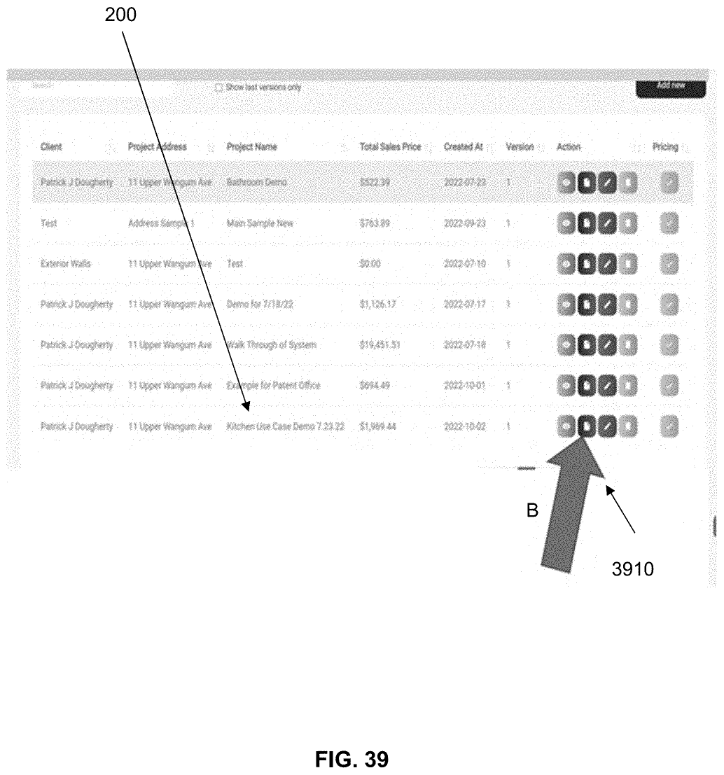

To provide a report designed for use by the vendor and/or client, attention is directed to FIG. 39. In one embodiment, the client interacts with quotation template 200. For example, the client can click on the report tab 3910 on quotation template (as shown by arrow B).

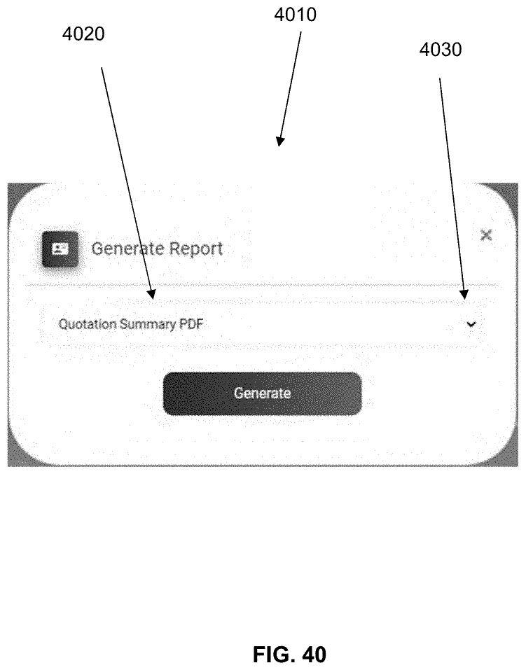

Upon clicking on the report tab 3910 in the quotation template 200, as shown in FIG. 40, the application server 120 is configured to prepare and present (generate and transmit) to the client a display 4010 that allows the client to generate a client/vendor report. In one embodiment, display 4010 includes a drop-down menu 4030 that includes the quotation summary PDF section 4020.

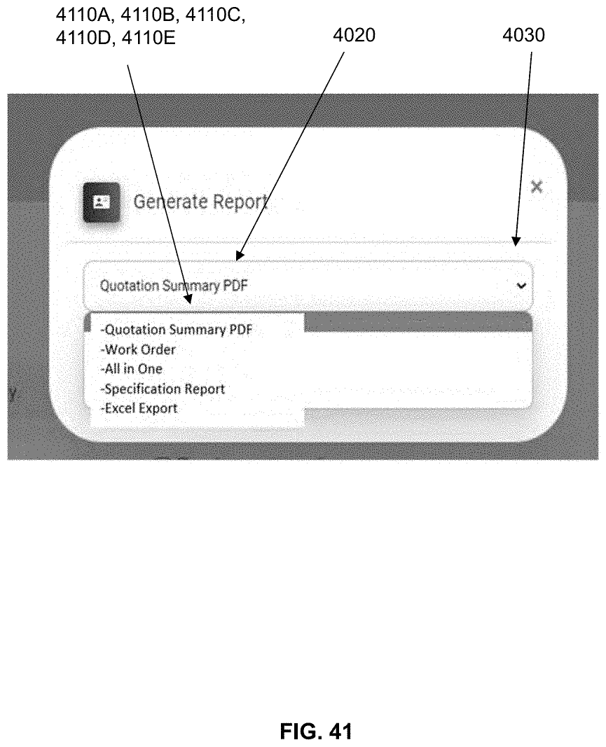

Upon clicking the drop-down menu 4030, as shown in FIG. 41, the client is presented with a plurality of questions 4110A-4110E related to the quotation summary PDF section 4020. In one embodiment, if the client desires to generate a quotation summary report in a PDF version, the client can click on the quotation summary PDF question 4110A.

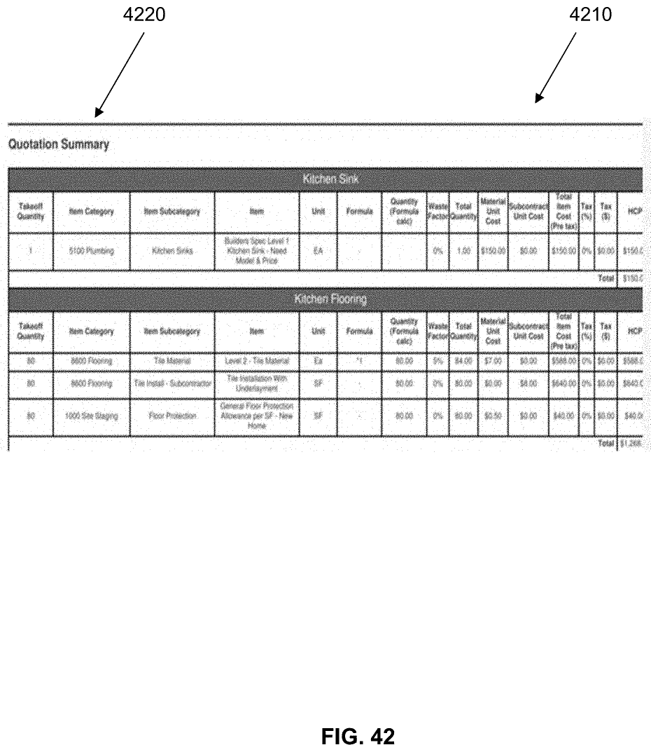

As shown in FIG. 42, once the client clicks on the quotation summary PDF question 4110A, the application server 12 is configured to prepare and present (generate and transmit) to the client a data structure (such as a display 4210) that shows the quotation summary report 4220.

Another practical application of the present invention is that the quotation summary report 4220 is intended to be an internal business document. In one embodiment, the quotation summary report 4220 can show the costs that have been determined under each quotation template section and the details associated with each item and/or assembly in each quotation template section. This report is of significant importance to the client and/or vendor since this quotation summary report 4220 sets forth in detail the item category (and the assembly category, if needed), the item subcategory (and the assembly subcategory, if needed), the item name (and assembly name, if needed), the unit (i.e., square footage, number of items or assemblies), the total quantity of the item (and assembly, if needed), the material unit cost for each item (and assembly, if needed), the subcontractor unit cost for each item (and each assembly, if needed), the total pre-tax item cost (and assembly cost, if needed), the tax percentage for each item (and assembly, if needed), the tax (in dollars) for each item (and each assembly, if needed), and the HCP for each item (and each assembly, if needed).

A practical application of the present invention is the use of the machine learning model to select the vendor who will provide the best price (i.e., lowest) for a particular item and/or provide the best service in relation to a particular item, assembly and/or product as shown in the quotation summary report 4220. As discussed above, the machine learning model is configured to update the pricing of any assemblies and/or projects that include that particular item. In this manner, if a particular item is requested by a client, the machine learning model is configured to query the item database and the vendor database and retrieve information related to the particular item such as vendor, selection information, accounting information, vendor delivery of the item, cost, job cost code, specification content, location tag, upgrade information, digital catalog controls, and content. The machine learning model is then configured to determine the lowest cost for the particular item and return to the client the lowest cost for that item and the vendor associated with the lowest cost. Finally, the application server 120 is configured to generate and transmit the lowest price in the quotation summary report 4220.

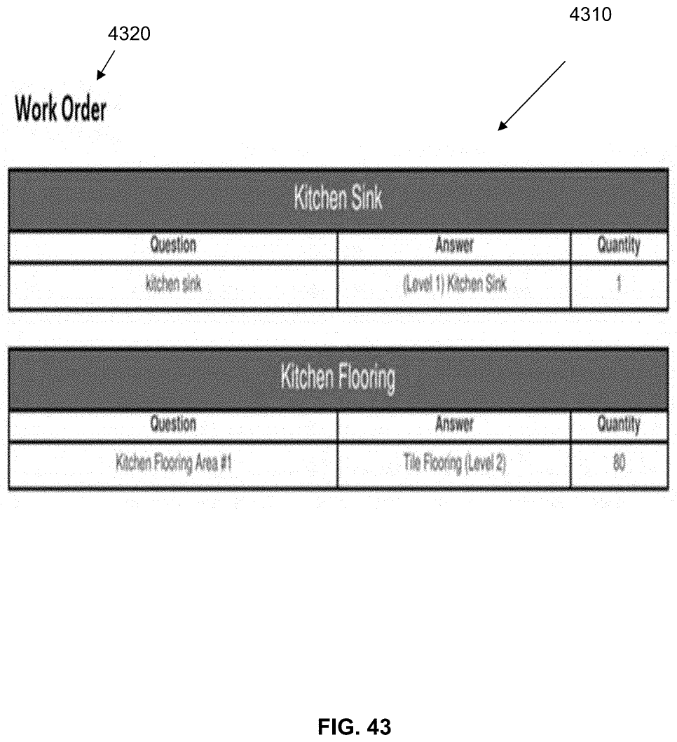

Returning to FIG. 41, if the client clicks on the work order question 4110B, as shown in FIG. 43, the application server 120 is configured to prepare and present (generate and transmit) to the client a data structure (such as a display 4310) that shows the work order 4320. In one embodiment, the work order 4320 is designed to be an internal and customer (end user) facing document. In particular, the work order 4320 summarizes the section questions, answers, and quantities in the quotation template 200.

Another practical application of the present invention is that work order 4320 can provide the client and/or the end user (customer) with a concise listing of the items and/or assemblies needed to complete the end user's project. For example, the work order 4320 in FIG. 43 informs the client and/or the end user that a question in the kitchen sink subsection section of the quotation template was answered. In particular, the answer to the kitchen sink question was the answer (Level 1) kitchen sink, and the quantity selected was one. This means that the client and/or end user selected the installation of one (Level 1) kitchen sink in the end user's project.

Furthermore, the work order 4320 informs the client and/or the end user that a question in the kitchen flooring subsection of the quotation template was answered. In particular, the answer to the kitchen flooring area #1 question was the answer tile flooring (Level 2) kitchen sink and the quantity selected was 80 square feet. This means that the client and/or end user selected the installation of 80 square feet of (Level 2) tile flooring in the end user's project.

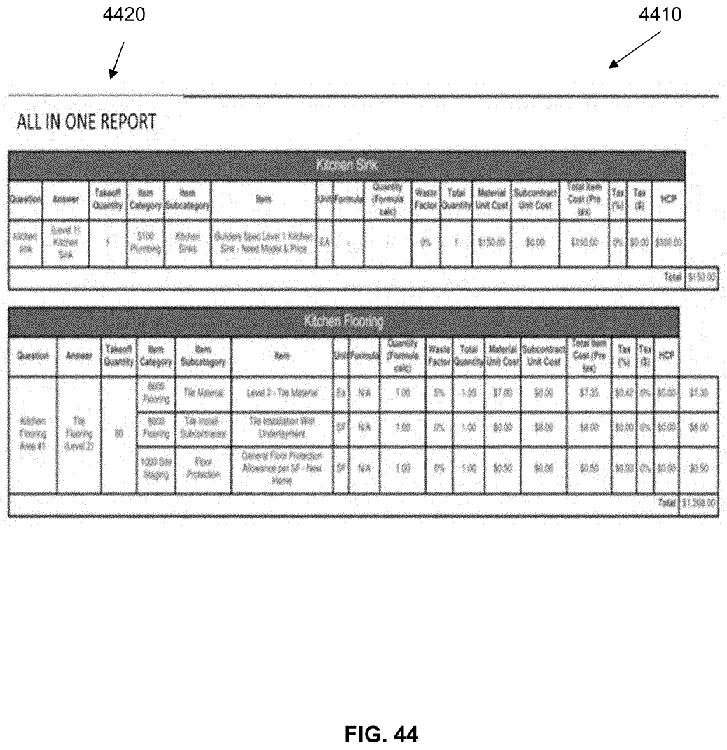

Returning to FIG. 41, if the client clicks on the all-in-one question 4110C, as shown in FIG. 44, the application server 12 is configured to prepare and present (generate and transmit) to the client a data structure (such as a display 4410) that shows the all-in-one report 44420. In one embodiment, the all-in-one report 4420 is designed to be an internal business document. In particular, the all-in-one report 4420 shows what items (and, if necessary, assemblies) each answer in the quotation template provided as a response.

Another practical application of the present invention is that the all-in-one report 4420 can provide the client with a concise listing of the items and/or assemblies needed to complete the end user's project. For example, the all-in-one report 4420 informs the client exactly what the item is to be installed (i.e., Level 1 Kitchen Sink). Furthermore, the all-in-one report 4420 can also include the various subcategories related to an item (tile material, tile install, and floor protection) that will be needed to install the item (i.e., tile flooring). In particular, the answer to the kitchen sink section in the quotation template is (Level 1) Kitchen Sink. The all-in-one report 4420 provides the details needed to purchase and install the kitchen sink. Likewise, the answer to the kitchen flooring section in the quotation template is tile flooring (Level 2). The all-in-one report 4420 provides the details needed to purchase and install the kitchen flooring, including subcontractor information.

A practical application of the present invention is the use of the machine learning model to select the vendor who will provide the best price (i.e., lowest) for a particular item and/or provide the best service in relation to a particular item, assembly and/or product as shown in the all in one report 4420. In particular, as discussed above, the machine learning model is configured to update the pricing of any assemblies and/or projects that include that particular item. In this manner, if a particular item is requested by a client, the machine learning model is configured to query the item database and retrieve information related to the particular item, such as vendor, selection information, accounting information, vendor delivery of the item, cost, job cost code, specification content, location tag, upgrade information, digital catalog controls, and content. The machine learning model is then configured to determine the lowest cost for the particular item and return the client the lowest cost for that item and the vendor associated with the lowest cost. Finally, the application server 120 is configured to generate and transmit the lowest price in the all-in-one report 4420.

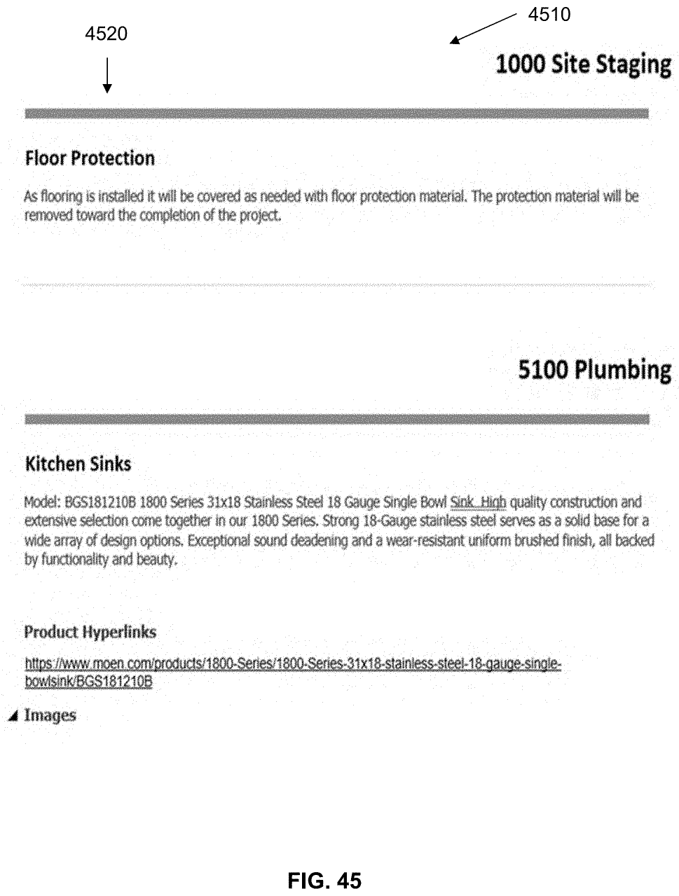

Returning to FIG. 41, if the client clicks on the specification report 4110D, as shown in FIG. 45, the application server 12 is configured to prepare and present (generate and transmit) to the client a data structure (such as a display 4510) that shows the specification report 4520. In one embodiment, the specification report 4520 is designed to be a customer-facing contractual document. In particular, the specifications report 4520 discloses the details about the items (and, if necessary, assemblies) needed for the project, including the services necessary to complete the project.

In one embodiment, the specifications report 4520 may include, for example, how the floor protection (FIG. 44) will be used during the completion of the project. Furthermore, the specification report 4520 can include a detailed description of the Level 1 Kitchen sink. Another practical application of the present invention is that the specification report 4520 can include an image of the item (along with a URL link) so that the end user can see what the item actually looks like.

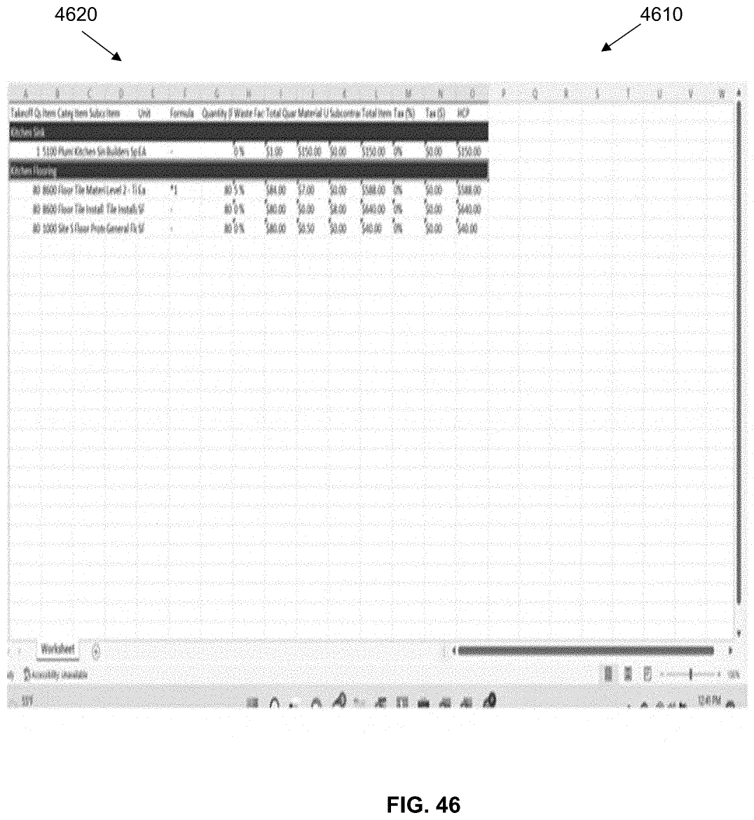

Finally, returning back to FIG. 41, if the client clicks on the excel export question 4110E, as shown in FIG. 46, the application server 12 is configured to prepare and present (generate and transmit) to the client a data structure (such as a display 4610) that shows the spreadsheet report 4620. In one embodiment, the spreadsheet report 4620 is designed to be an internal business document. In particular, the spreadsheet report 4620 will allow the client to import project estimate data from the vendors for the purpose of purchasing, project management, and accounting.

Another practical application of the present invention is that the spreadsheet report 4620 can provide to the client a concise method of purchasing, project management, and accounting needed to complete the end user's project. For example, spreadsheet report 4620 informs the client exactly what the item is to be installed related to the answer to a question in the quotation template section (i.e., Kitchen Sink). Furthermore, the spreadsheet report 4620 can also include the various subcategories related to an item (tile material, tile install, and floor protection) that will be needed to install the item (i.e., tile flooring). In particular, the answer to the kitchen sink section in the quotation template is (Level 1) Kitchen Sink. The spreadsheet report 4620 provides the details needed to purchase and install the kitchen sink. Likewise, the answer to the kitchen flooring section in the quotation template is tile flooring (Level 2). The spreadsheet report 4620 provides the details needed to purchase and install the kitchen flooring including an subcontractor information.

A practical application of the present invention is the use of the machine learning model to select the vendor who will provide the best price (i.e., lowest) for a particular item and/or provide the best service in relation to a particular item, assembly and/or product as shown in the spreadsheet report 4620. As discussed above, the machine learning model is configured to update the pricing of any assemblies and/or projects that include that particular item. In this manner, if a particular item is requested by a client, the machine learning model is configured to query the item database and retrieve information related to the particular item such as vendor, selection information, accounting information, vendor delivery of the item, cost, job cost code, specification content, location tag, upgrade information, digital catalog controls, and content. The machine learning model is then configured to determine the lowest cost for the particular item and return to the client the lowest cost for that item and the vendor associated with the lowest cost. Finally, the application server 120 is configured to generate and transmit the lowest price in the spreadsheet report 4620.

In one embodiment, a computerized management system can use the data from reports 4420 and/or 4620 to control at least one enterprise function performed by the computerized management system. For example, an inventory allocation function can be controlled by the data from reports 4420 and/or 4620 to first direct available inventory towards work areas (such as construction sites, garages, work sites or the like) where materials listed in the reports 4420 and/or 4460 will need to be shipped, before directing inventory to other work areas. Such a computerized management system may be an enterprise resource planning (ERP) system or an inventory management and demand forecasting system, for example. In one embodiment, the data from reports 4420 and/or 4620 may be used to control robots and/or inventory machines to identify, retrieve, and move/transport selected items/assemblies/products to destination locations (e.g., work areas).

Referring again to FIG. 25B, at block 2550, in one embodiment, an electronic message is generated by system 100 that includes predicted project pricing. It is to be understood that the predicted project pricing will also include the items, assemblies, and/or projects needed to complete a project, along with the costs and fees required to install the items, assemblies, and/or projects. In another embodiment, the electronic message includes an order (such as report 4420 and/or 4460) for a set of items based upon the data in reports 4420 and/or 4460. The order may include a set of inventory items that are identified to be transported to selected work areas. The inventory items and/or selected work areas are selected based at least in part on one group of the data in reports 4420 and/or 4460. In one embodiment as described below, the electronic message is generated as (and/or includes) control instructions for a robotic mechanism of an inventory system.

The electronic message may be transmitted (e.g., via network communications) to a remote computing system (e.g., a computerized management system) located at a warehouse or the like to cause the remote computing system to perform at least one enterprise function. For example, the enterprise function may be an inventory allocation function, a demand forecasting function, or a market segmentation function.

The electronic message may also be sent to a vendor's warehouse (or fulfillment center), where warehouse-management software or similar inventory system receives the order. The systems at the warehouse fulfill the order by retrieving the items/units from a unit storage location, packaging the units, and preparing them for shipping. In one embodiment, the systems are controlled at least in part by the instructions in the order. If the retrieved items are located at the warehouse, the retrieved items are transported to the work areas.

The inventory systems may include, for example, automated robotic machines or mechanisms configured to locate and retrieve items from warehouse or store locations based on the order and/or rearrange items in different locations based on the order (e.g., add selected items, remove selected items, based on the items identified in the order). The robotic mechanism delivers the retrieved items to automated packaging mechanisms that package the retrieved items in the warehouse or transport the retrieved items to a different location.

In one embodiment, the robotic mechanisms may include one or more robots configured to navigate throughout a given warehouse or store, locate and retrieve items, and carry items to a destination. Each robot may include at least a body structure, a power source, a control interface, a wired/wireless communication interface, a drive device to move the robot, a navigation device, one or more sensors, and/or a balance device. Of course, the robot may be configured in different ways and multiple different types of robots may be operating together in the robotic mechanism of the warehouse or store. For example, if the robot determines that a particular item in the order is currently not available, the robot can then notify management personnel at the warehouse that the desired item is not in stock.

In one or more embodiments, the robotic mechanisms may include one or more of the following systems. Automated Guided Vehicles (AGVs) for transporting materials, supplies, and inventory within warehouse or store facilities. An AGV may be configured to autonomously navigate warehouse or store facilities by following defined routes marked by wires, magnetic strips, tracks, sensors embedded in the floor or other physical guides. The AGV may also be navigated by a defined map of the warehouse or store based on a coordinate system and a tracked location of the AGV. Cameras may also be used to navigate an AGV. Another robotic mechanism is Automated Storage and Retrieval Systems (AS/RS) which may include a group of computer-controlled systems that automate inventory management and store/retrieve goods on demand from storage locations in the warehouse or store. The AS/RS may operate either as cranes or shuttles on fixed tracks and can traverse product aisles and vertical heights to remove items or drop off items from storage. Another robotic mechanism is articulated robotic arms that are a type of pick-and-place robot. These arms can move, turn, grab/release, lift and move items with, for example, multi-jointed limbs used to manipulate products.

After the retrieved items are transported to a packaging area of the warehouse, the items for the order are packaged by an automated system. This may include cartonization software that determines quantity, size, and type of container required to package of the order, and/or bagging machines that help speed up packaging operations. As discussed above, after the retrieved items are transported to the work areas, the retrieved items can then be used to complete the project outlined in the order.

The packaged order is transferred to a shipper, or if the retailer has its own shipment operation, then the retailer's own trucks will take the shipment. The status of the order is changed to “in transit” in the inventory-management system. The order arrives at the work area it is destined for. Finally, the computerized management system software then updates the inventory position of the retrieved items at the work areas.

In another embodiment, an electronic message is generated for end users or clients, where the message is used to initiate an action from an end user or client. The electronic message may be generated with a link that is configured to provide network-accessible access to a selected website location over a network communication. The link and selected website location may include information related to reports 4420, 4320, and/or 4520 that may cause the end user and/or client to review the report.

The electronic message including the link is transmitted to a remote device/account (e.g., via end user or client email address, text address, etc.) associated with the end user or client. In response to selection of the link from a remote device, network access is established from the remote device to the selected website location and access is granted to the selected website location. The remote device is then enabled to generate a display of the report 4420, 4320, and/or 4520 from the selected website location. The end user or client, if desired, can then place an order to selected items from the display. The order can then be processed, retrieved, and transported to the end user or client, as discussed above.

In another embodiment, the system may generate both types of electronic messages: a first message the includes the order and which is used to control a robotic mechanism, and a second message to one or more end users or clients including a link that is sent to selected end users and/or clients to access a website.

### Computing Device Embodiment

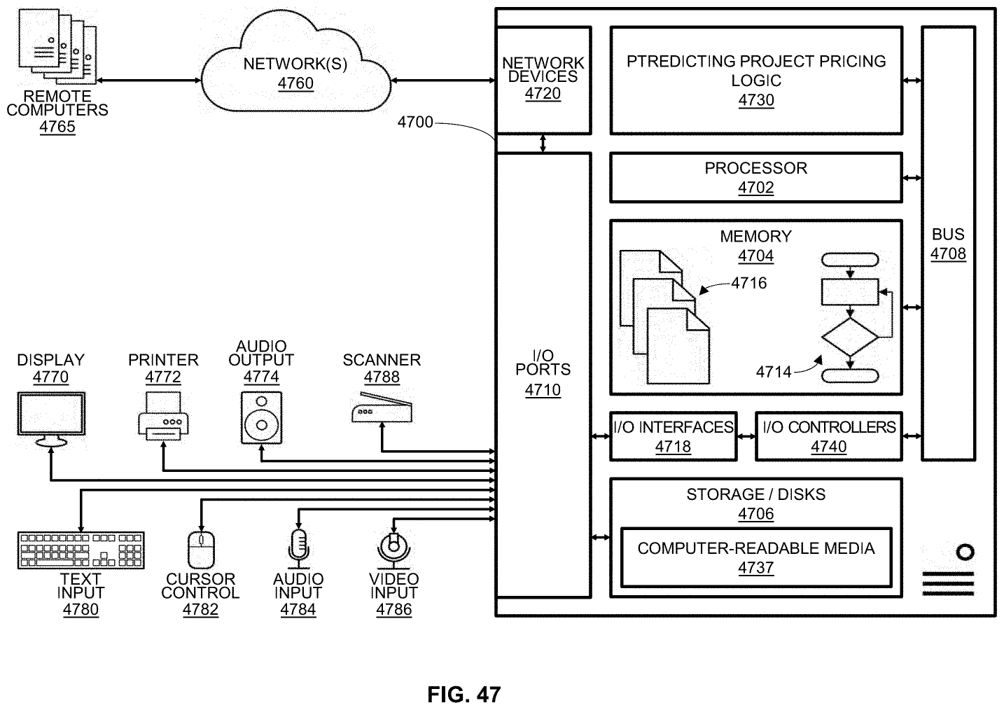

FIG. 47 illustrates an example computing device configured and/or programmed as a special-purpose computing device with one or more of the example systems and methods described herein and/or equivalents. The example computing device may be a computer 4700 that includes at least one hardware processor 4702, a memory 4704, and input/output ports 4710 operably connected by a bus 4708. In one example, the computer 4700 may include predicting project pricing logic 4730 configured to facilitate the prediction of a project price based upon the usage of quotation templates and an item/assembly/project database similar to logic/systems shown in FIGS. 1, 25A and 25B.

In different examples, the logic 4730 may be implemented in hardware, a non-transitory computer-readable medium 4737 with stored instructions, firmware, and/or combinations thereof. While the logic 4730 is illustrated as a hardware component attached to the bus 4708, it is to be appreciated that in other embodiments, the logic 4730 could be implemented in the processor 4702, stored in memory 4704, or stored in disk 4706.

In one embodiment, logic 4730 or the computer is a means (e.g., structure: hardware, non-transitory computer-readable medium, firmware) for performing the actions described. In some embodiments, the computing device may be a server operating in a cloud computing system, a server configured in a Software as a Service (SaaS) architecture, a smart phone, laptop, tablet computing device, and so on.

The means may be implemented, for example, as an ASIC programmed to predict a product demand. The means may also be implemented as stored computer executable instructions that are presented to computer 4700 as data 4716 that are temporarily stored in memory 4704 and then executed by processor 4702.

Logic 4730 may also provide means (e.g., hardware, non-transitory computer-readable medium that stores executable instructions, firmware) for predicting a product demand.

Generally describing an example configuration of the computer 4700, the processor 4702 may be a variety of various processors including dual microprocessor and other multi-processor architectures. A memory 4704 may include volatile memory and/or non-volatile memory. Non-volatile memory may include, for example, ROM, PROM, and so on. Volatile memory may include, for example, RAM, SRAM, DRAM, and so on.

A storage disk 4706 may be operably connected to the computer 4700 via, for example, an input/output (I/O) interface (e.g., card, device) 4718 and an input/output port 4710 that are controlled by at least an input/output (I/O) controller 4740. The disk 4706 may be, for example, a magnetic disk drive, a solid-state disk drive, a floppy disk drive, a tape drive, a Zip drive, a flash memory card, a memory stick, and so on. Furthermore, the disk 4706 may be a CD-ROM drive, a CD-R drive, a CD-RW drive, a DVD ROM, and so on. The memory 4704 can store a process 4714 and/or a data 4716, for example. The disk 4706 and/or the memory 4704 can store an operating system that controls and allocates resources of the computer 4700.

The computer 4700 may interact with, control, and/or be controlled by input/output (I/O) devices via the input/output (I/O) controller 4740, the I/O interfaces 4718, and the input/output ports 4710. Input/output devices may include, for example, one or more displays 4770, printers 4772 (such as inkjet, laser, or 3D printers), audio output devices 4774 (such as speakers or headphones), text input devices 4780 (such as keyboards), cursor control devices 4782 for pointing and selection inputs (such as mice, trackballs, touch screens, joysticks, pointing sticks, electronic styluses, electronic pen tablets), audio input devices 4784 (such as microphones or external audio players), video input devices 4786 (such as video and still cameras, or external video players), image scanners 4788, video cards (not shown), disks 4706, network devices 4720, and so on. The input/output ports 4710 may include, for example, serial ports, parallel ports, and USB ports.

The computer 4700 can operate in a network environment and thus may be connected to the network devices 4720 via the I/O interfaces 4718 and/or the i/O ports 4710. Through network devices 4720, computer 4700 may interact with a network 4760. Through the network, computer 4700 may be logically connected to remote computers 4765. Networks with which the computer 4700 may interact include, but are not limited to, a LAN, a WAN, and other networks.

### Definitions and Other Embodiments

In another embodiment, the described methods and/or their equivalents may be implemented with computer executable instructions. Thus, in one embodiment, a non-transitory computer readable/storage medium is configured with stored computer executable instructions of an algorithm/executable application that when executed by a machine(s) cause the machine(s) (and/or associated components) to perform the method. Example machines include but are not limited to a processor, a computer, a server operating in a cloud computing system, a server configured in a Software as a Service (SaaS) architecture, a smart phone, and so on). In one embodiment, a computing device is implemented with one or more executable algorithms that are configured to perform any of the disclosed methods.

In one or more embodiments, the disclosed methods or their equivalents are performed by either: computer hardware configured to perform the method; or computer instructions embodied in a module stored in a non-transitory computer-readable medium where the instructions are configured as an executable algorithm configured to perform the method when executed by at least a processor of a computing device.

While for purposes of simplicity of explanation, the illustrated methodologies in the figures are shown and described as a series of blocks of an algorithm, it is to be appreciated that the methodologies are not limited by the order of the blocks. Some blocks can occur in different orders and/or concurrently with other blocks from that shown and described. Moreover, less than all the illustrated blocks may be used to implement an example methodology. Blocks may be combined or separated into multiple actions/components. Furthermore, additional and/or alternative methodologies can employ additional actions that are not illustrated in blocks. The methods described herein are limited to statutory subject matter under 35 U.S.C § 101.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

A “data structure”, as used herein, is an organization of data in a computing system that is stored in a memory, a storage device, or other computerized system. A data structure may be any one of, for example, a data field, a data file, a data array, a data record, a database, a data table, a graph, a tree, a linked list, and so on. A data structure may be formed from and contain many other data structures (e.g., a database includes many data records). Other examples of data structures are possible as well, in accordance with other embodiments.

“Computer-readable medium” or “computer storage medium”, as used herein, refers to a non-transitory medium that stores instructions and/or data configured to perform one or more of the disclosed functions when executed. Data may function as instructions in some embodiments. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read only memory (ROM), a memory chip or card, a memory stick, solid state storage device (SSD), flash drive, and other media from which a computer, a processor or other electronic device can function with. Each type of media, if selected for implementation in one embodiment, may include stored instructions of an algorithm configured to perform one or more of the disclosed and/or claimed functions. Computer-readable media described herein are limited to statutory subject matter under 35 U.S.C § 101.

“Logic”, as used herein, represents a component that is implemented with computer or electrical hardware, a non-transitory medium with stored instructions of an executable application or program module, and/or combinations of these to perform any of the functions or actions as disclosed herein, and/or to cause a function or action from another logic, method, and/or system to be performed as disclosed herein. Equivalent logic may include firmware, a microprocessor programmed with an algorithm, a discrete logic (e.g., ASIC), at least one circuit, an analog circuit, a digital circuit, a programmed logic device, a memory device containing instructions of an algorithm, and so on, any of which may be configured to perform one or more of the disclosed functions. In one embodiment, logic may include one or more gates, combinations of gates, or other circuit components configured to perform one or more of the disclosed functions. Where multiple logics are described, it may be possible to incorporate the multiple logics into one logic. Similarly, where a single logic is described, it may be possible to distribute that single logic between multiple logics. In one embodiment, one or more of these logics are corresponding structure associated with performing the disclosed and/or claimed functions. Choice of which type of logic to implement may be based on desired system conditions or specifications. For example, if greater speed is a consideration, then hardware would be selected to implement functions. If a lower cost is a consideration, then stored instructions/executable application would be selected to implement the functions. Logic is limited to statutory subject matter under 35 U.S.C. § 101.

An “operable connection”, or a connection by which entities are “operably connected”, is one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other directly or through one or more intermediate entities (e.g., processor, operating system, logic, non-transitory computer-readable medium). Logical and/or physical communication channels can be used to create an operable connection.

“User”, as used herein, includes but is not limited to one or more persons, computers or other devices, or combinations of these.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or the illustrative examples shown and described. Thus, this disclosure is intended to embrace alterations, modifications, and variations that fall within the scope of the appended claims, which satisfy the statutory subject matter requirements of 35 U.S.C. § 101.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive use.

What is claimed is:

1. A computer-implemented method performed by a computing device, where the computing device includes at least a processor for executing instructions from a memory, the method comprising:
providing, by an application server, a quotation template having at least one category;
in response to selecting the at least one category, providing, by the application server, at least one section that is associated with the at least one category;
in response to selecting the at least one section, providing, by the application server, at least one question that is associated with the at least one section;
in response to selecting at least one question, providing, by the application server, at least one answer that is associated with the at least one question;
in response to selecting the at least one answer, providing, by the application server, at least one response that is associated with the at least one answer;
generating, by the application server, an electronic message, wherein the electronic message includes a data structure which presents an order for a set of items based upon the response;
transmitting, by the application server, the electronic message to a remote computer;
in response to receiving the electronic message, fulfilling the order by providing instructions to a robotic mechanism to cause the robotic mechanism to autonomously navigate through associated item storage locations in order to locate and retrieve the set of items from the associated item storage locations based upon the order;
transporting the retrieved set of items to a work area; and
completing a project based upon the retrieved set of items.

2. The method of claim 1, wherein the data structure further comprises:
the at least one question; and
the at least one answer.

3. The method of claim 1, further comprising:
providing, by the application server, a user interface that allows a user to add the at least one category to the quotation template;
providing, by the application server, a user interface that allows the user to add the at least one section to the at least one category;
providing, by the application server, a user interface that allows the user to add the at least one question to the at least one section;
providing, by the application server, a user interface that allows the user to add the at least one answer to the at least one question; and
providing, by the application server, a user interface that allows the user to add the at least one response to the at least answer.

4. The method of claim 1, wherein the method further comprises:
inputting user information into the quotation template; and
inputting project information into the quotation template.

5. The method of claim 1, wherein the data structure further comprises:
a quotation summary report.

6. The method of claim 1, wherein the data structure further comprises:
an all-in-one report.

7. The method of claim 1, wherein the data structure further comprises:
a work order report.

8. A non-transitory computer-readable medium storing computer-executable instructions that, when executed by a computer including a processor, cause the computer to perform functions configured by the computer-executable instructions, wherein the instructions comprise:
provide, by an application server, a quotation template having at least one category;
in response to selecting the at least one category, provide, by the application server, at least one section that is associated with the at least one category;
in response to selecting the at least one section, provide, by the application server, at least one question that is associated with the at least one section;
in response to selecting at least one question, provide, by the application server, at least one answer that is associated with the at least one question;
in response to selecting the at least one answer, provide, by the application server, at least one response that is associated with the at least one answer;
generate, by the application server, an electronic message, wherein the electronic message includes a data structure which presents an order for a set of items based upon the response;
transmit, by the application server, the electronic message to a remote computer;
in response to receiving the electronic message, fulfilling the order by providing instructions to a robotic mechanism to cause the robotic mechanism to autonomously navigate through associated item storage locations in order to locate and retrieve the set of items from the associated item storage locations based upon the order;
transport the retrieved set of items to a work area; and
complete a project based upon the retrieved set of items.

9. The non-transitory computer-readable medium of claim 8, wherein the data structure further comprises:
the question; and
the answer.

10. The non-transitory computer-readable medium of claim 8, further comprising instructions that, when executed by at least the processor, cause the processor to:
provide, by the application server, a user interface that allows a user to add the at least one category to the quotation template;
provide, by the application server, a user interface that allows the user to add the at least one section to the at least one category;
provide, by the application server, a user interface that allows the user to add the at least one question to the at least one section;
provide, by the application server, a user interface that allows the user to add the at least one answer to the at least one question; and
provide, by the application server, a user interface that allows the user to add the at least one response to the at least answer.

11. The non-transitory computer-readable medium of claim 8, wherein the instructions further comprises instructions that, when executed by at least the processor, cause the processor to:
input user information into the quotation template; and
input project information into the quotation template.

12. The non-transitory computer-readable medium of claim 8, wherein the data structure further comprises:
a quotation summary report.

13. The non-transitory computer-readable medium of claim 8, wherein the data structure further comprises:
an all-in-one report.

14. The non-transitory computer-readable medium of claim 8, wherein the data structure further comprises:
a work order report.

15. A computing system, comprising:
at least one processor connected to at least one memory;
a non-transitory computer readable medium including instructions stored thereon that, when executed by the at least one processor, cause the at least one processor to:
provide, by an application server, a quotation template having at least one category;
in response to selecting the at least one category, provide, by the application server, at least one section that is associated with the at least one category;
in response to selecting the at least one section, provide, by the application server, at least one question that is associated with the at least one section;
in response to selecting at least one question, provide, by the application server, at least one answer that is associated with the at least one question;
in response to selecting the at least one answer, provide, by the application server, at least one response that is associated with the at least one answer;
generate, by the application server, an electronic message, wherein the electronic message includes a data structure which presents an order for a set of items based upon the response;
transmit, by the application server, the electronic message to a remote computer;
in response to receiving the electronic message, fulfill the order by providing instructions to a robotic mechanism to cause the robotic mechanism to autonomously navigate through associated item storage locations in order to locate and retrieve the set of items from the associated item storage locations based upon the order;
transport the retrieved set of items to a work area; and
complete a project based upon the retrieved set of items.

16. The computing system of claim 15, wherein the data structure further comprises:
the question; and
the answer.

17. The computing system of claim 15, wherein the instructions further include instructions that, when executed by at least the processor, cause the processor to:
provide, by the application server, a user interface that allows a user to add the at least one category to the quotation template;
provide, by the application server, a user interface that allows the user to add the at least one section to the at least one category;
provide, by the application server, a user interface that allows the user to add the at least one question to the at least one section;
provide, by the application server, a user interface that allows the user to add the at least one answer to the at least one question; and
provide, by the application server, a user interface that allows the user to add the at least one response to the at least answer.

18. The computing system of claim 15, wherein the instructions further comprises instructions that, when executed by at least the processor, cause the processor to:
input user information into the quotation template; and
input project information into the quotation template.

19. The computing system of claim 15, wherein the data structure further comprises:
a quotation summary report.

20. The computing system of claim 15, wherein the data structure further comprises:
an all-in-one report.
